(19) United States
(12) Patent Application Publication
(10) Pub. No.: US 2023/0056634 A1
(43) Pub. Date: Feb. 23, 2023

(54) SYSTEMS AND METHODS OF AUTOMATING FIRE SUPPRESSANT SYSTEM DESIGN

(71) Applicant: Viking Group, Inc., Caledonia, MI (US)

(72) Inventors: Brendan M. KERRIGAN, Sterling, MA (US); John F. TOMKO, Earlysville, VA (US)

(21) Appl. No.: 17/771,058

(22) PCT Filed: Nov. 6, 2020
(86) PCT No.: PCT/US2020/059459

§ 371 Date: Apr. 22, 2022

Related U.S. Application Data
(60) Provisional application No. 62/932,855, filed on Nov. 8, 2019.
(60) Provisional application No. 62/932,896, filed on Nov. 8, 2019.
(60) Provisional application No. 62/932,924, filed on Nov. 8, 2019.
(60) Provisional application No. 62/932,939, filed on Nov. 8, 2019.
(60) Provisional application No. 62/932,953, filed on Nov. 8, 2019.

(51) Int. Cl. G06F 30/18

(52) U.S. Cl. CPC G06F 30/18; A62C 99/00

(57) ABSTRACT

Disclosed embodiments are directed at automating aspects of the design of a fire suppressant system. A computer-implemented fire suppressant design assistant can facilitate engineers, architects, plumbers, and fire protection personnel, regardless of their skill level, to design a fire suppressant system for a particular building or space. The disclosed assistant enables customizations by allowing pipes and fittings made of different materials or produced by different manufacturers. In some embodiments, the disclosed assistant generates a computer model of a fire suppressant system represented as a pipe network including an interconnected set of components. In some embodiments, the disclosed assistant generates information related to directionality details of the pipes in the pipe network of the computer model representation. In some embodiments, the disclosed assistant generates a manifold pipe type for use in computer modeling and visualization. In some embodiments, the disclosed assistant generates a preferred container configuration

### PRIORITY CLAIM & INCORPORATION BY REFERENCE

This application claims the benefit of U.S. Provisional Application No. 62/932,855, filed Nov. 8, 2019; U.S. Provisional Application No. 62/932,896, filed Nov. 8, 2019; U.S. Provisional Application No. 62/932,924, filed Nov. 8, 2019; U.S. Provisional Application No. 62/932,939, filed Nov. 8, 2019; and U.S. Provisional Application No. 62/932,953, filed Nov. 8, 2019; all of which are incorporated by reference herein in their entireties.

### TECHNICAL FIELDS

This disclosure is directed toward computer-aided design of fire suppressant systems. More specifically, the present technology is directed to designing or tracing multi-component fire suppressant systems on a computer, based on considering several factors such as dimensions of the physical space to be protected from fire, physical and chemical properties of fire suppressant agent fluids, dimensions of the components in a fire suppressant system assembly, details of the components in a fire suppressant system assembly, and/or specificities of the above-mentioned factors.

### BACKGROUND

Generally, a fire suppressant is used for the protection of residential, commercial, and industrial facilities that can contain humans, sensitive equipment, valuable items, etc. Various types of fire suppressant agents can be used in fire suppressant systems to protect these facilities. For example, fire suppressant agents can be liquid-based, foam-based, or gas-based. The choice of a fire suppressant agent depends on the type of assets being protected. A fire suppressant system for use in a facility is generally subject to industry-accepted fire code requirements and the approval of pertinent jurisdictional authority to ensure compliance with the applicable codes and requirements.

### SUMMARY

Embodiments of the present disclosure are directed at automating the design of fire suppressant systems, for example, using a general-purpose or a special-purpose computer. The fire suppressant system designed using a computer preferably provides an electronic blueprint of a fire suppressant system that can be installed in a building or any real-world facility for protecting assets within the facility. The present technology provides a convenient design process and a computer-based visualization (e.g., for use by a professional or a designer) of the fire suppressant system assembly which can be utilized for approval of the design, installation of the fire suppressant system in a real-world facility, and necessary documentation of the fire suppressant system assembly. A fire suppressant system assembly utilizes a fire suppressant agent (e.g., stored in cylinders or containers) to provide protection from fires. In the context of the present disclosure, the term “fire suppressant agent” preferably refers to chemical or a mixture of chemicals that are in wet, dry, or gaseous form, and that excludes pure water-based chemicals. Furthermore, in the context of the present disclosure, the term “fire suppressant system” preferably covers the multitude of components (pipes, tees, cylinders storing fire suppressant agents, elbows, nozzles and other components) pertinent to designing a fire suppressant system.

In some embodiments, a fire suppressant system is preferably represented as a pipe network which includes an interconnected set of mechanical components (such as pipes, tees, elbows, reducers, sprinklers, couplings, etc.) oriented in 3D space. The pipe network connects cylinders storing fire suppressant agents to one or more rooms in the facility that house one or more assets to be protected. In some embodiments, the fire suppressant system design is generated based on a processor of the computer implementing a set of steps of a process for designing a fire suppressant system. (References to “a method” or “the method” herein are directed at such computer-performed steps of a process.)

In some embodiments, the disclosed technology can facilitate generating a computer model of a fire suppressant system design. The computer can receive inputs (e.g., a component-by-component tracing or by other indications provided by a user) describing the components of the pipe network. The inputs received from a user or a fire protection professional is preferably in the form of a file upload or entered via a graphical user interface (GUI) of an application program. Using the received inputs corresponding to components of the pipe network, the computer identifies at least one pipe as one of the inputs and generates a multi-element configuration of the pipe. In other words, a pipe (or, generally any component of a pipe network) is preferably represented in a computer model with a multi-element configuration. For example, the multi-element configuration can specify dimensions, directionality, part numbers (IDs), and other such attributes of the pipe. Further, in some embodiments, the method can map the origin of the pipe network to a pipe network component. The origin of the pipe network is preferably mapped to one end of a cylinder storing a fire suppressant agent. In such an embodiment, the origin is preferably identified as the point where the first pipe is attached to the cylinder. After identifying an origin, the method can include identifying a termination point based on a nozzle, a cap, or other terminating fittings in the inputs received from the user. After identification of the components of the pipe network, the method can include traversing the pipe network from the termination point to the origin, thereby generating a computer model representation of the pipe network.

In some embodiments, generating the computer model of the pipe network includes supplementing the computer model with additional details of the pipes included in the model. For example, a method to determine the additional details of a pipe can include determining whether the pipe is oriented along an axis in a specified set of axes, or otherwise determining a gradient of a pipe. It will occur to one of ordinary skill that it is possible a pipe in a fire suppressant system design can be oriented at an angle with respect to at least one of the axes and not necessarily aligned along X, Y, and/or Z directions, in either positive or negative directions. Thus, the method can first identify a pipe and then determine a normalized directionality of the pipe. Determining a normalized directionality results in the pipe getting re-oriented along one of the computer-defined X, Y, or Z axes in the computer-generated pipe network model. If the method determines that a selected pipe from the pipes in a pipe network fails to be aligned along one of the defined X, Y, or Z axes in either positive or negative directions, the method identifies an adjacent component coupled to the selected pipe. Also, in order to compute a gradient along an axis of the selected pipe, the method identifies an “end” (e.g., identified according to presence of a connector) of the adjacent component and then determines which of the two ends of the pipe is farthest from the “end.” Relative to the directionality of the adjacent component, and a position of the farthest end of the selected pipe, the method assigns a normalized directionality of the selected pipe. The above-mentioned method is applicable repeatedly to other pipes in the pipe network, thereby generating a computer model representation of the pipe network with additional information related to directionality details of the pipes in the pipe network.

In some embodiments, generating a computer model representation of the pipe network can include computing a pipe fitting length by replacing a pipe length provided as an input with the true length of the pipe. In many instances, the inputs (e.g., received from a user or a fire suppressant system designer) describing the components of the pipe network may not factor in dimensions of fittings attached to the ends of the pipe. For example, this can arise in fire protection hydraulics in which the hydraulics calculations typically ignore the elbow or other fitting attached to the end of a pipe. In those embodiments, the computer model determines true or actual pipe dimensions to generate an accurate design of a fire suppressant system. The method to compute a pipe fitting length is based on identifying at least two connectors located at two ends of a fitting attached to a pipe. Next, these connectors are used to computationally calculate an intersection point (inside the fitting) of straight lines from the two connectors. Using the intersection point where straight lines from the two connectors meet, the method can calculate an offset distance between the intersection point and one of the connectors. This offset distance is added/summed to the length of the pipe to compute the true length of the pipe, thereby generating a computer model representation of the pipe network with true pipe lengths.

In some embodiments, disclosed embodiments are used to generate a “manifold pipe type” for use in a computer modeling and visualization software. A manifold pipe type is a special-purpose pipe used in the field of fire suppression systems and refers to a sub-assembly of main pipes carrying fire suppressant agents from containers (e.g., cylinders) storing the fire suppressant agents to a room in a facility that houses assets to be protected. The manifold pipe type is preferably used to generate computer visualizations using appropriate dimensions such as spacings between pipes, spacings between containers, and container diameters. These dimensions are pre-determined or selected by the designer in accordance with compliance standards. Typically, the material of the manifold pipe type conforms to Schedule 40 steel or Schedule 80 steel standards.

The disclosed method for generating a manifold pipe type can automatically create a cylinder manifold that can be conveniently used in a computer model for further processing and/or visualization on a computer monitor. The method can include receiving a container bank configuration, e.g., a diameter of the main pipe, a length of the side pipe, a number of containers in the container bank, a volume of each container in the container bank, a dimension of a transition fitting on the main pipe, etc. Next, the method identifies a first connector and a second connector associated with containers in the container bank. In some implementations, the first connector is preferably on the end of the main pipe that is closest to/vertically above the last container in the container bank. The second connector is preferably on the other end of the section of the main pipe such that the second connector is closest to/vertically above the second-to-last container in the container bank. Using the identified first and second connectors, the method generates data specifying a portion of the main pipe between the first connector and the second connector and, additionally, data specifying a side pipe between the first connector and the check valve closest to the last container. Conceptually, the above steps would result in representations of the main pipe and a side pipe being generated. In some implementations, generating the data specifying the main pipe and the side pipes can be performed iteratively. At each step of the iteration, a sub-portion of the container bank configuration is generated. Multiple sub-portions are preferably combined to generate data for the overall container bank configuration. The generated data for the overall container bank configuration corresponds to the manifold pipe type, which can be imported as a custom “component” or “element” in a computer-aided design (CAD) software such as the REVIT^{®} software offered by AUTODESK, INC. In some embodiments, the method optionally verifies that the transition fittings attached to the main pipe are in accordance with rules associated with container bank parameters. The rules can also specify which transition fittings are not allowed (e.g., 45s, couplers, or crosses) to be included in the container bank configuration. A rule can specify that each container storing a fire suppressant agent is required to have a check valve for compliance with one or more standards associated with designs of fire suppressant systems. Accordingly, based on the rules, the method can detect mismatches between the size of a transition fitting and the size of the main pipe.

In some embodiments, disclosed embodiments are preferably used in computing physical configuration of containers storing fire suppressant agents. Because fire suppressant agents are water-based, gas-based, or foam-based, and can be stored in containers of different sizes, it will be appreciated that more than one container configuration is possible. Advantageously, disclosed embodiments can provide a method to determine a configuration of containers that meets the designer’s specifications, or otherwise determine a preferred container configuration in some embodiments. The method includes receiving parameters of a room in a facility where assets are to be protected. Room parameters can include dimensions of the room where the assets are located. Additionally, room parameters can optionally include dimensions of one or more nearby rooms where the fire suppressant system will be placed. In some implementations, the room parameters are received from a CAD database (e.g., a REVIT^{®} database). In some implementations, the room parameters are received from a fire suppressant system designer, e.g., in the form of a file upload or entered via a GUI. Using the received room parameters, the method computes a volume and/or a floor space area to be protected. The method can optionally receive physical and chemical discharge parameters of a fire suppressant agent for protecting the assets or use default values of such parameters. The physical and discharge parameters are preferably used to compute the weight of a fire suppressant agent. Examples of physical and discharge parameters include a type of fire suppressant agent, a time taken to discharge the fire suppressant agent from a cylinder storing the fire suppressant agent at a specified pressure, and others. Based on the room volume and the discharge parameters, the method first computes a fire suppressant agent discharge quantity for the room, which is used to calculate a number of cylinders storing fire suppressant agents. Everything considered equal, smaller containers are more effective to provide cost savings. However, if the number of smaller containers exceeds the number of larger containers, then a small container configuration may not be effective. Hence, in some implementations, the method can optionally perform an optimization operation to determine the lowest number of containers in the smallest size. Further, in some embodiments, the method can determine whether a single-cylinder configuration or a multi-cylinder configuration (container bank) is better suited for fire protection. Therefore, fire suppressant systems designed by incorporating the above-mentioned optimization(s) can result in maximum utilization of physical space.

### BRIEF DESCRIPTION OF THE DRAWINGS

While the present invention(s) has/have been disclosed with reference to certain embodiments, numerous modifications, alterations, and changes to the described embodiments are possible without departing from the sphere and scope of the present invention(s), as defined in the appended claims. Accordingly, it is intended that the present invention(s) not be limited to the described embodiments, but that it has the full scope defined by the language of the following claims and equivalents thereof.

FIG. 1 is a block diagram illustrating an overview of an environment in which some implementations of automated systems for designing fire suppressant systems can operate.

FIG. 2A illustrates an example implementation of a fire suppressant system.

FIG. 2B illustrates another example implementation of a fire suppressant system.

FIG. 2C illustrates a top view of the example implementation of FIG. 2B.

FIG. 3 is a block diagram illustrating components which, in some implementations, can be used in a system employing the disclosed technology.

FIG. 4 is another block diagram illustrating components which, in some implementations, can be used in a system employing the disclosed technology.

FIG. 5 illustrates example database entries corresponding to a representative room drawn using computer-aided design (CAD) software.

FIG. 6 illustrates example parameters of a room.

FIGS. 7A and 7B are conceptual diagrams illustrating example views of a pipe network drawn using CAD software.

FIG. 7C illustrates an example database entry corresponding to the pipe network diagram shown in FIGS. 7A and 7B.

FIGS. 8A-8D are conceptual diagrams illustrating examples of origins of a pipe network.

FIGS. 9A-9C are conceptual diagrams illustrating examples of directionalities of a pipe in a pipe network.

FIG. 10 is a flow diagram illustrating a process used in some implementations for tracing a pipe network.

FIG. 11 is a flow diagram illustrating a process used in some implementations for computing a normalized directionality of a pipe.

FIG. 12 is an example table showing parameters of cylinders storing fire suppressant agents.

FIG. 13 is an example dialog box of a graphical user interface (GUI) illustrating discharge parameters of a fire suppressant agent.

FIG. 14 illustrates an example fire suppressant agent container configuration.

FIG. 15 is a flow diagram illustrating a process used in some implementations for computing a fire suppressant agent container configuration.

FIG. 16 illustrates examples of parameters defining a container bank.

FIG. 17 is a flow diagram illustrating a process used in some implementations for generating data specifying a manifold.

FIG. 18 is a conceptual diagram illustrating an example of a pipe fitting length.

FIGS. 19A and 19B are conceptual diagrams illustrating a first example of calculations of pipe fitting length.

FIGS. 20A and 20B are conceptual diagrams illustrating a second example of calculations of pipe fitting length.

FIG. 21 is a flow diagram illustrating a process used in some implementations for calculating a pipe fitting length.

FIG. 22 is a flow diagram illustrating a process used in some implementations for generating a pipe network model.

FIGS. 23A-23C are conceptual diagrams illustrating representations of a pipe network model.

FIG. 24 is a table illustrating examples of discharge nozzle parameters.

FIG. 25A is a conceptual diagram illustrating an example of proportions of fluid flow through pipes attached to a first tee fitting.

FIG. 25B is a conceptual diagram illustrating an example of proportions of fluid flow through pipes attached to a second tee fitting.

### DETAILED DESCRIPTION

Embodiments of the present disclosure are directed at automating design of fire suppressant systems. A fire suppression agent is typically stored in one or more cylinders located in the same room, an adjacent room, or a nearby room with respect to the room where assets to be protected are placed. Upon detection of a fire, the fire suppressant agent is discharged from the cylinder(s) into the room housing the assets. A computer-implemented assistant is disclosed for automating aspects of designing fire suppressant systems. For example, the disclosed assistant preferably provides use as an automated tool for designing or computationally modeling a fire suppressant system that meets compliance standards and is in accordance with dimensions or configurations of a building or a facility for the fire suppressant system. In some embodiments, the disclosed assistant can generate a computer model of the fire suppressant system that is preferably visualized using a computer program.

The disclosed assistant for designing fire suppressant systems can take into consideration dimensions of the room to be protected from fire (e.g., housing assets), physical and chemical discharge parameters of the fire suppressant agent, and dimensions of a pipe network (along with associated components such as tees, elbows, couplings, reducers, nozzles, caps, etc.) connecting the cylinders to the room that houses the critical assets.

Conventionally, designing fire suppressant systems can be complicated, lengthy, and cumbersome. Further, most fire suppressant system designs are created manually, requiring highly experienced professionals with years of experience in the fire protection industry. Even where some automation is provided, it is limited to certain stages of the design process, e.g., during stages of visualizing rooms or facilities of a building where cylinders storing fire suppressant agents are to be located. Commercial, off-the-shelf building information modeling (BIM) software typically used for visualization purposes, however, cannot perform hydraulics calculations and computations associated with designing a fire suppressant system.

Furthermore, in many instances, the BIM software does not allow customizations that might be preferred by a designer of a fire suppressant system. Thus, the designer is not able to rely on conventional automation systems where customizations are necessary. Designs of fire suppressant systems created using conventional systems, as a result, are typically “overdesigned” or conservatively designed to factor in possible human errors. For example, when a fire suppressant system is designed conservatively, extra amounts (more than what is needed to meet building specifications or compliance standards) of fire suppressant agents are factored into the design. Accordingly, overdesigned systems can end up being unnecessarily expensive as well as poorly designed.

Even further, currently available BIM software lacks interactivity. For example, the software usually does not provide notifications or error messages to inform the user of errors in inputs for designing fire suppression systems. If input parameters or conditions are invalid or erroneous, currently available BIM software is not able to detect invalid parameters or conditions because such software is simply not equipped to handle invalid parameters or conditions. Thus, often the designer is left with no guidance to determine what the input condition errors were.

The lack of automation in current systems for designing fire suppressant systems results in several challenges in complying with standards. For example, it can be challenging for a designer to electronically verify whether a fire suppressant system meets the standards of a particular jurisdiction. As a result, the designer has to manually look up lengthy, voluminous charts from multiple vendors and compare them to standards to determine whether the design is in compliance. Because a fire suppressant system has a wide variety of parts (such as pipes, fittings, tees, supply cylinders, couplings, etc.), which can come from a host of manufacturers, not only can checking for compliance be frustrating, but it can also lead to errors.

The disclosed technology overcomes several limitations of conventional systems with a computer-implemented assistant which receives room/building configurations, compliance data for a jurisdiction or a fire protection standard, and/or manufacturer’s specifications (e.g., dimensions of components of a system) and generates a computer model as output that is preferably used to construct a fire suppressant system with the components for fitting into a real-world building. In some embodiments, the disclosed assistant is a software program configured to run on a computer system. As an example, the disclosed assistant can be used by engineers, architects, plumbers, and fire protection personnel, regardless of their skill level. In some embodiments, the disclosed assistant is preferably configured to include a graphical user interface (GUI) that makes the design process simple, interactive, and easy. In some embodiments, advantageously, the disclosed assistant includes several modules that allow customizations in designing fire suppressant systems. For example, if a designer wishes to use pipes and fittings made of different materials or produced by different manufacturers, such customizations in design are allowed by the disclosed assistant. As another advantage, the disclosed assistant is preferably coupled to a database tailored to meet compliance standards of a jurisdiction. Yet another advantage of the disclosed assistant is that it provides messages and/or notifications in response to receiving erroneous input and/or non-compliant parameters of components. A further advantage is that the notifications can be provided at intermediate stages of the automated design process. This can be beneficial in helping a designer to know whether the design process is successfully moving forward through the intermediate stages.

Fire suppression systems are used to extinguish or prevent the spread of fire in a building. Various fire suppression systems use a combination of dry chemicals and/or wet agents to suppress fires. In some scenarios, conventional fire suppressant agents such as pure water, carbon dioxide, or foam may not be applicable to protect against fire. For example, water or foam can cause severe damage or destroy costly electronic equipment (e.g., electronic data storage systems and IT equipment) at data centers, or valuable materials (e.g., antiques/art) in a museum.

To protect certain types of assets, a fire suppressant agent which is electrically non-conductive and does not leave a residue upon evaporation is preferably well suited. One example of such a fire suppressant is a “clean agent.” Unlike conventional fire suppressant agents, a clean agent uses inert gases and/or chemical agents to extinguish a fire. National Fire Protection Association (NFPA) Standard 2001 defines a clean agent as an electrically non-conductive gaseous fire extinguishant that does not leave a residue upon evaporation. Examples of popular clean agents are FM-200™ and Novec 1230™ manufactured by 3M™ Company. Others include FE-13™, FE-25™, Nitrogen, Argon, Inergen™, Argonite™, and Halon.

Clean agents are ideal for hazard areas requiring a reliable, corrosion-resistant fire extinguisher that is electrically non-conductive and will not cause thermal shock damage. A clean agent can control and extinguish a fire in a very short time interval (e.g., 10 seconds or less) before the fire spreads. Because clean agent systems are controlled by electronic detectors or based on manual activation, they are activated much more quickly than sprinkler-based systems, which are activated by heat. Clean agent fire extinguishers are environmentally friendly, leave no residue, require no cleanup after discharge, and are safer for equipment/assets being protected. Further, clean agents use gases that are generally not harmful to humans. Advantageously, the embodiments disclosed in this document are generally applicable for any type of fire suppressant agents, including clean agents. In this disclosure, the terms “fire suppressant” and “fire suppressant agents” are generally synonymous. Several implementations are discussed below in more detail in reference to the figures.

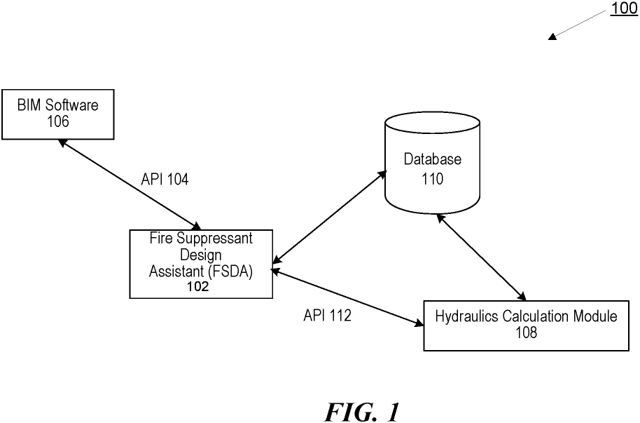

Turning to the figures, FIG. 1 is a block diagram illustrating an overview of an environment in which some implementations of automated systems for fire suppressant system design can operate. In some embodiments, a computer-implemented fire suppressant design assistant (FSDA) 102 (equivalently termed as fire suppressant system design assistant) is communicably coupled to building information modeling (BIM) software 106, hydraulics calculation module 108, and database 110. FIG. 1 shows FSDA 102 coupled to BIM software 106 via application programming interface (API) 104. FSDA 102 is preferably coupled to hydraulics calculation module 108 via API 112. FSDA 102 can exchange (send and/or receive) data relating to designing fire suppressant systems with database 110 (e.g., an SQL database). In some embodiments, database 110 and FSDA 102 can be part of a single computer or the same computing network/environment. In some embodiments, FSDA 102 communicates with an external database 110. Similarly, BIM software 106 and/or hydraulics calculation module 108 can be either local or externally located from FSDA 102.

Database 110 can store data describing dimensions of various mechanical parts or components of the fire suppressant system to be designed, component ID or part ID of pipe network components, physical and chemical parameters and properties of fire suppressant agents, compliance data for one or more jurisdictions, default values of components, default values of discharge parameters of fire suppressant agents, configuration data of buildings or rooms, floor area, ceiling area, volume, length/breadth/height data of rooms, etc. Although FIG. 1 shows a single database, in alternate implementations, FSDA 102 can be coupled to multiple databases.

The fire suppressant system design generated by FSDA 102 is preferably output as a computer model that can be used to construct a fire suppressant system with physical components that fits into a real-world building. As input, FSDA 102 can receive room/building configurations, compliance data for a jurisdiction, dimensions of components of the fire suppressant system to be designed, physical and chemical parameters of fire suppressant agents, and other such information. Devices that can be used to input information into FSDA 102 include, for example, a mouse, a keyboard, a touchscreen, an infrared sensor, a touchpad, a wearable input device, a camera- or image-based input device, and a microphone. In some implementations, FSDA 102 can connect to one or more LCD or LED displays, touchscreens, heads-up display devices, or head-mounted devices for display of text and graphics. I/O devices can also be coupled to FSDA 102 through a network card, video card, audio card, USB, firewire, or other external device, camera, printer, speakers, CD-ROM drive, DVD drive, disk drive, or Blu-ray device.

In some implementations, FSDA 102 is preferably configured as an add-in or a plug-in for integration into BIM software 106. For example, BIM software 106 can be a computer-aided design (CAD) software such as AUTODESK REVIT^{®}, and the disclosed FSDA 102 is preferably integrated into a REVIT^{®} toolbar. Icons corresponding to one or more features and functionalities of the FSDA 102 disclosed herein is preferably displayed on the REVIT^{®} toolbar. Advantageously, this can enable fire protection professionals to leverage the features and functionalities of FSDA 102 to develop more efficient and accurate workflows in REVIT^{®}. Further, a feature or a functionality of the FSDA 102 disclosed herein can be implemented using aspects of a method, a system, or a computer-readable medium.

In some implementations, FSDA 102 is preferably a stand-alone program. In some implementations, FSDA 102 is preferably a software program hosted on one or more servers accessible by other computing systems (e.g., via API calls) and humans (e.g., designers of fire suppression systems).

In some embodiments, FSDA 102 is preferably configured as a computing system including a single processor or multiple processors and memory storing instructions for automating aspects of designing a fire suppressant system. Memory includes one or more of various hardware devices for volatile and non-volatile storage and can include both read-only and writable memory. For example, memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. Memory is not a propagating signal divorced from underlying hardware; memory is thus non-transitory. Memory can include program memory that stores programs and software, such as an operating system, FSDA 102, and other application programs. Memory can also include data memory that can include data describing dimensions of various mechanical parts or components of the system to be designed, physical and chemical parameters and properties of fire suppressant agents, compliance data for one or more jurisdictions, configuration data of buildings or rooms, settings, user options or preferences, etc.

In some implementations, the computing system associated with FSDA 102 also includes a communication device capable of communicating wirelessly or wire-based with a network node. The communication device can communicate with another device or a server through a network using, for example, TCP/IP protocols. In some embodiments, FSDA 102 can utilize the communication device to distribute operations across multiple network devices.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

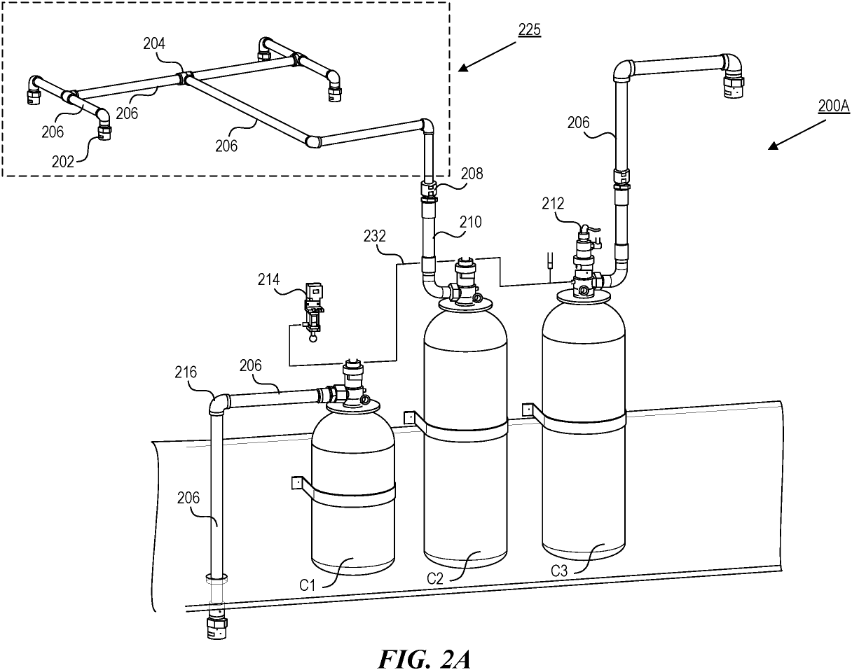

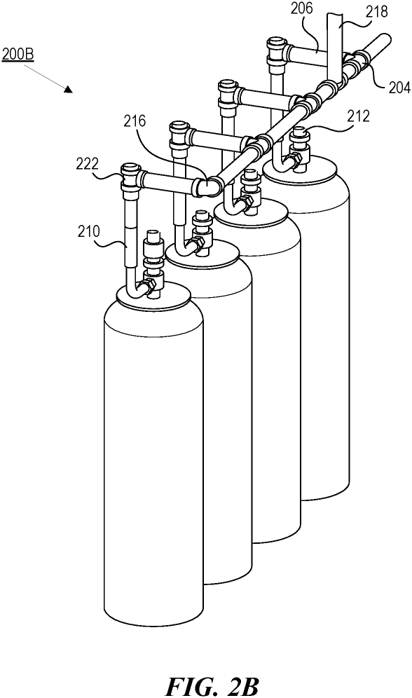

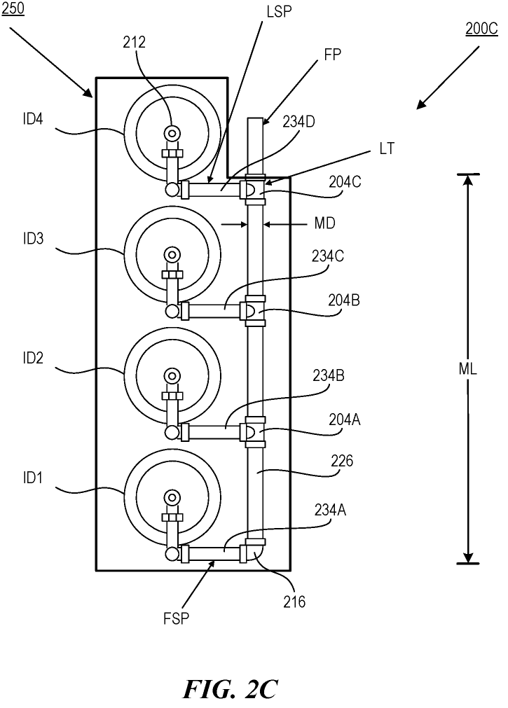

FIG. 2A illustrates an example implementation of a fire suppressant system. FIG. 2A shows various components of a pipe network 200A connected to three single cylinders storing fire suppressant agents. Cylinder 1 (denoted C1 in FIG. 2A), cylinder 2 (denoted C2 in FIG. 2A), and cylinder 3 (denoted C3 in FIG. 2A) are connected to different pipes. Cylinder 1 is connected to one of pipes 206, which is further connected to elbow 216 (e.g., a bent fitting). Elbow 216 is coupled to two additional ones of pipes 206 at its two ends. Cylinder 2 is connected to flexible (flex) hose 210, which is further connected to union 208. A pipe union (or, simply a union) is a type of fitting that unites two pipes which can be detached without causing any deformation to the pipes. Union 208 is connected to a pipe included in pipe network 225, which is a sub-set of pipe network 200A.

One end of pipe 206 in pipe network 225 is attached to nozzle 202, which is the point of discharge of the fire suppressant agent. For example, nozzle 202 can be located on a ceiling or the walls of the room housing assets to be protected.

FIG. 2A shows pilot hose line 232 (typically made of rubber with galvanized steel ends) joining cylinder 1, cylinder 2, and cylinder 3. A function of pilot hose line 232 is to “open” cylinder 1 and cylinder 2. For example, cylinder 3 actuates first. As a result, fire suppressant agent flows through pilot hose line 232 to cylinder 2, and then through pilot hose line 232 to cylinder 1. In FIG. 2A, cylinder 3 is preferably regarded or designated as the control cylinder, whereas cylinder 1 and cylinder 2 are preferably regarded as slave containers. cylinder 3 can be electrically actuated (with an option for manual actuation e.g., using a manual release knob). cylinder 1 and cylinder 2 (e.g., slave containers) can be fitted with pneumatic release devices. One end of pilot hose line 232 terminates at actuator 214. The top of cylinder 3 includes check valve 212 for controlling discharge or flow of the fire suppressant agent stored in cylinder 3 in one direction and preventing flow in the opposite direction. It will be appreciated that the disclosed technology is broadly applicable to accommodate design of a fire suppressant system using pipe network components made of different materials, and even from different manufacturers/vendors.

FIG. 2B illustrates another example implementation of a fire suppressant system. For example, FIG. 2B shows various components of a pipe network 200B connected to four cylinders storing fire suppressant agents. The configuration shown in FIG. 2B is alternatively referred to as a multi-container system or a manifold. In contrast to single container systems (e.g., as shown in FIG. 2A), the fire suppressant agent released in a multi-container system first flows from flex hose 210 via check valves 212 to a manifold. The manifold is used to connect multiple cylinders on a common supply line. In FIG. 2B, the manifold is connected to center pipe 218. Typically, the pipes and fittings of a manifold are compliant with standards (e.g., NFPA 2001).

FIG. 2C illustrates a top view 200C of a manifold corresponding to the example implementation of FIG. 2B. For example, FIG. 2C shows four cylinders storing fire suppressant agents connected to manifold 226 and identified with labels ID1, ID2, ID3, and ID4. A first side pipe 234A connects to the manifold 226 via elbow 216. Three other side pipes 234B, 234C, and 234D connect to manifold 226 via tees 204A, 204B, and 204C. As shown in FIG. 2C, the length of the manifold (denoted ML) is the length of manifold 226 connected commonly to the cylinders. The diameter of the manifold (denoted MD) is the diameter of manifold 226. The length of each of the side pipes 234A, 234B, 234C, 234D is calculated as the distance between check valve 212 and manifold 226. Examples of parameters defining a manifold are preferably a length of a manifold, a diameter of a manifold, an identification of a last tee, an identification of a last side pipe (denoted LSP in FIG. 2C), an identification of a first side pipe (denoted FSP in FIG. 2C), a length of a side pipe, and/or an identification of a first pipe (denoted FP in FIG. 2C).

In some implementations, the disclosed technology enables using one or more of the above-mentioned parameters for a computer-generated visualization of the container configuration in a manifold. For example, using the diameter of the manifold and the length of a side pipe, the disclosed fire suppressant design assistant is preferably configured to generate data specifying region 250. Furthermore, for identifying or tracing a pipe network, the point where the first pipe begins after the last tee (denoted LT) in the collection of cylinders is preferably considered as an origin (or, supply point) of a pipe network. It will be understood that although the discussions in FIG. 2C are illustrated with the above-mentioned manifold parameters, in alternate implementations, a manifold can be defined in terms of other parameters. Also, a manifold can include other pipe network components (e.g., a reducer or a coupling).

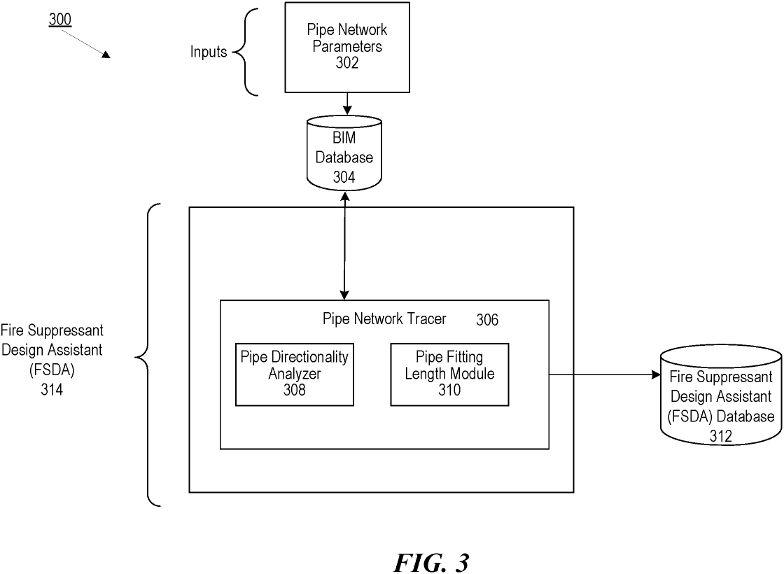

FIG. 3 is a block diagram 300 illustrating components which, in some implementations, can be used in a system employing the disclosed fire suppressant design assistant technology. To generate a computer model of a pipe network that can be used to construct a fire suppressant system that fits into a real-world building, FSDA 314 receives pipe network parameters 302 (e.g., dimensions of components of the pipe network and associated descriptions) as input. In some embodiments, for generating the computer model and/or identifying components included in the pipe network, FSDA 314 can include a pipe network tracer 306 for tracing the components included in the pipe network. Tracing a pipe network can include FSDA 314 parsing through a list of database entries corresponding to components of the pipe network. In some embodiments, the components of the pipe network is computationally represented as entries listed in a database. The entries are preferably data structures. For example, there can be a first data structure for a pipe component, a second data structure for an elbow, a third data structure for a tee, a fourth data structure for a reducer, and so on. As a result of tracing a pipe network, FSDA 314 can extract information about the pipe network. For example, FSDA 314 can identify various informational attributes of a pipe network component, such as dimensions, directionality, identifications of the connected next or preceding components, etc.

In some designs of a fire suppressant system, a pipe included as part of a pipe network may have an arbitrary orientation in 3D space. In those designs, pipe directionality analyzer 308 can compute a normalized directionality of the pipe that re-orients the pipe to a specified axis (e.g., one of positive/negative on an X, Y, or Z axis) based on whether the directionality of another pipe directly or indirectly connected to the pipe is oriented along one of the X, Y, or Z axes. That is, although the real-world orientation of the pipe is arbitrary (or, otherwise as entered by the designer), for purposes of tracing a pipe network computationally, embodiments of the disclosed FSDA include a pipe directionality analyzer 308 that re-orients the pipe along one of an X, Y, or Z axis for representation of the pipe as part of a computer model of a pipe network.

In fire suppressant system designs, accurate lengths of pipes or pipe section lengths may not be available. A pipe section length refers to the length of a pipe and any fittings associated with or attached to the pipe. For example, when a pipe is attached to an elbow, in many instances, the dimensions of the elbow are not accounted for. This, however, can result in poorly designed fire suppressant systems. Advantageously, pipe fitting length module 310 in the disclosed FSDA 314 can accurately determine a pipe fitting length of a pipe that is a combination of a length of a pipe and a size of an attached fitting. In some embodiments, accurately measured pipe dimensions are preferably used in calculation of hydraulics flow parameters of the fire suppressant system.

In some embodiments, FSDA 314 receives pipe network parameters 302 stored in a BIM database 304. For example, a designer can draw a pipe network or otherwise enter pipe network parameters 302 into a CAD program (e.g., REVIT®), which stores them as the pipe network parameters 302 in the coupled BIM database 304. In some embodiments, FSDA 314 receives pipe network parameters 302 directly (without BIM database 304) from a designer or another computing system. After receiving the pipe network parameters 302, pipe network tracer 306 loops through/iterates over the components of the pipe network to map or identify a termination point and an origin of the pipe network. Identifying a termination point can include identifying a nozzle or a cap in the pipe network parameters 302. Identifying an origin can include identifying a supply container (e.g., one or more cylinders storing fire suppressant agents). In some implementations, the model includes information identifying a spatial configuration or arrangement of the components of the pipe network, e.g., which component is connected to which other component. A model or other representation of a pipe network generated by pipe network tracer 306 is preferably saved in FSDA database 312. For example, FSDA 314 can store normalized directionalities of pipes in the pipe network, modified pipe lengths (by considering dimensions of fittings attached to pipes), information identifying an origin, information identifying a termination point, and/or information identifying how individual pipe network components are connected to one another. The blocks/modules of the FSDA 314 shown in FIG. 3 are merely for illustrative purposes. In alternate embodiments, other blocks/modules can be included in the FSDA 314. Alternately, one or more of the blocks/modules of the FSDA 314 shown in FIG. 3 can be decomposed into other sub-blocks or sub-modules, as will occur to one of ordinary skill in the art.

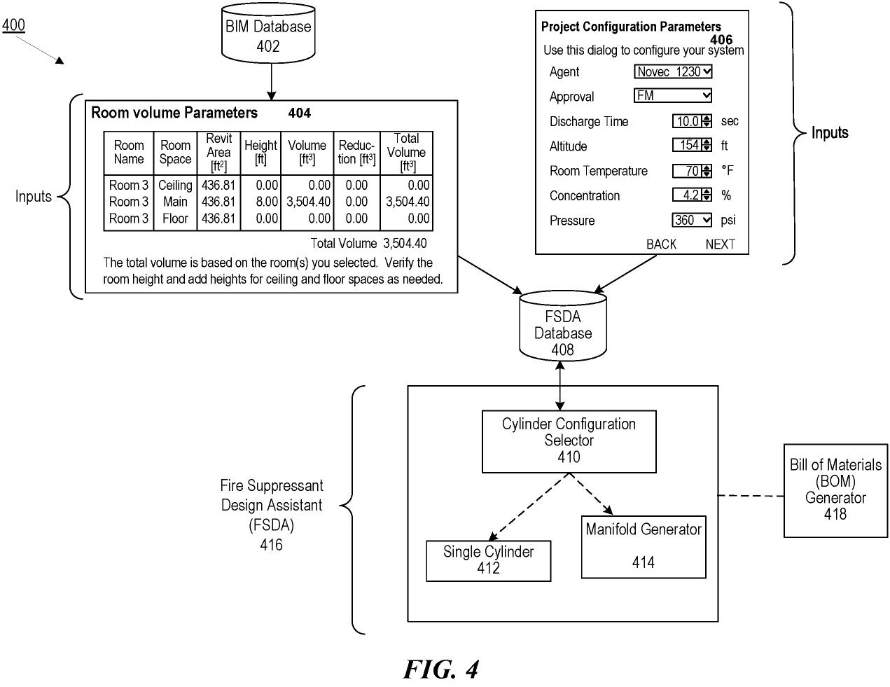

FIG. 4 is another block diagram illustrating components which, in some implementations, can be used in a system employing the disclosed fire suppressant design assistant technology. FIG. 4 shows room volume parameters 404 (e.g., a specification of a room from a real-world building where fire suppressant agent cylinders are to be placed) received as input (e.g., provided by BIM database 402). Room volume parameters 404 can correspond to dimensions of a floor, an area, or a zone to be protected from fire. Project configuration parameters 406 defining chemical and physical parameters of the fire suppressant agent can also be received. Examples of project configuration parameters 406 are preferably a type of fire suppressant agent, a time taken to discharge the fire suppressant agent from a cylinder, a measure of concentration of the fire suppressant agent to be used in the room/volume to be protected, a room temperature, a pressure of the fire suppressant agent stored in the cylinder, an altitude (from mean sea level) of the room, and manufacturer’s specifications associated with a cylinder. Examples of manufacturer’s specifications for a fire suppressant agent cylinder are preferably a maximum fillable quantity per cylinder, a volume of a cylinder, a residual amount of fire suppressant agent, etc. Room volume parameters 404 and project configuration parameters 406 can be saved in FSDA database 408.

Based on room volume parameters 404 and project configuration parameters 406, cylinder configuration selector 410 in FSDA 416 determines a fire suppressant agent discharge quantity for the room to be protected. Using the fire suppressant agent discharge quantity, cylinder configuration selector 410 can compute a fire suppressant agent container configuration. For example, cylinder configuration selector 410 can determine a number of fire suppressant agent cylinders based on dimensions of the room(s) where critical assets are to be housed, dimensions of cylinders storing fire suppressant agents, and/or physical and chemical discharge parameters of the fire suppressant agent.

Further, depending on room volume parameters 404 and project configuration parameters 406, the output of cylinder configuration selector 410 can also indicate (e.g., shown with dotted lines in FIG. 4) whether a single-cylinder configuration 412 or a multi-cylinder configuration (e.g., manifold generator 414) is recommended for given building specifications and discharge parameters of a fire suppressant agent. If the output is a single-cylinder configuration 412, then cylinder configuration selector 410 provides (as output) the number of fire suppressant agent cylinders that is preferably used in the fire suppressant system design, a volume of each container, and a total discharge volume of fire suppressant agent that can be used in the fire suppressant system design. If the output of cylinder configuration selector 410 is a multi-cylinder configuration, then cylinder configuration selector 410 provides options for additional processing steps. Additional processing steps can include generating container bank configuration data. For example, the container bank configuration data can include an identification of the main manifold pipe, one or more side pipes, or one or more transition fittings of the cylinder bank configuration. In some embodiments, cylinder configuration selector 410 can include logic and rules for verifying that the generated cylinder bank configuration meets manufacturer’s specifications and/or meets with jurisdiction-based safety codes of compliance standards.

In some embodiments, the disclosed FSDA 416 can include or connect to a module (e.g., bill of materials (BOM) generator module 418) that is preferably configured to generate a bill of materials, based on inputs such as pipe network parameters, room dimension data, or fire suppressant agent discharge parameters. The bill of materials is preferably in the form of a report including a quantity, part ID numbers of components included in the model, and a description of the multiple pipe network components of the pipe network. The bill of materials can optionally include fire protection hydraulic data. The bill of materials and/or resulting fire protection hydraulic data can be submitted to the authority having jurisdiction for approval of the fire suppressant system design. The components of the pipe network are listed and approved by UUFM. The hydraulics calculation engine is listed and approved by UL and FM.

If cylinder configuration selector 410 in FSDA 416 determines that a multi-cylinder configuration is recommended for given building specifications and fire suppressant agent discharge parameters, then manifold generator 414 can generate data specifying a manifold. The data specifying a manifold is preferably used to create a “manifold pipe type” for use in CAD software. The generated manifold is compliant with pipes and fittings used in the design of fire suppression systems.

In some embodiments, one or more blocks/modules of the FSDA 416 shown in FIG. 4 can be optional. For example, the FSDA 416 may or may not include one or more of the single-cylinder configuration 412 and/or the manifold generator 414 and/or the BOM generator 418 blocks. Furthermore, in some embodiments, certain aspects of the FSDA 416 can be integrated into another FSDA (e.g., FSDA 314 discussed in FIG. 3) as will occur to one skilled in the art.

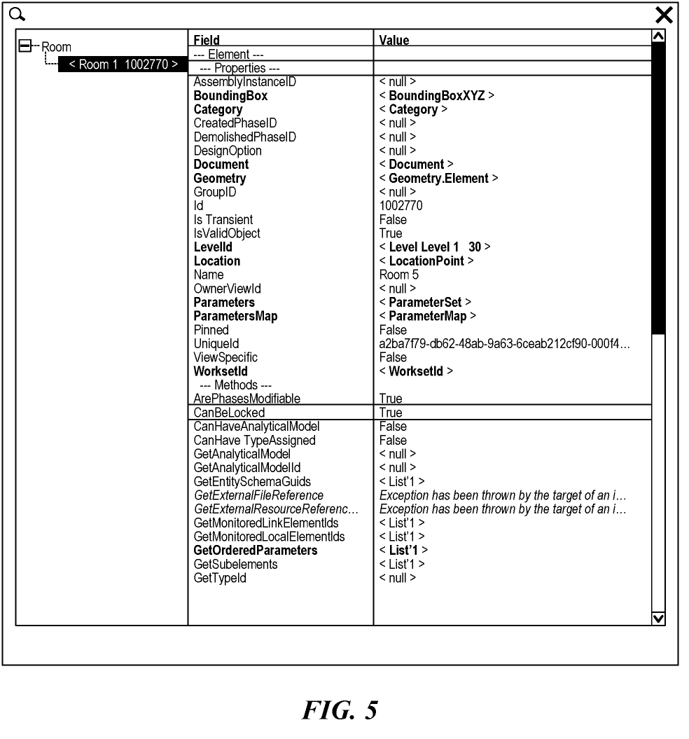

FIG. 5 illustrates example database entries corresponding to an example room (denoted Room 1) drawn using computer-aided design (CAD) software. The database entries shown in FIG. 5 are merely for illustration, and other database entries such as floor area, volume, ceiling space, and custom features of a room can also be listed.

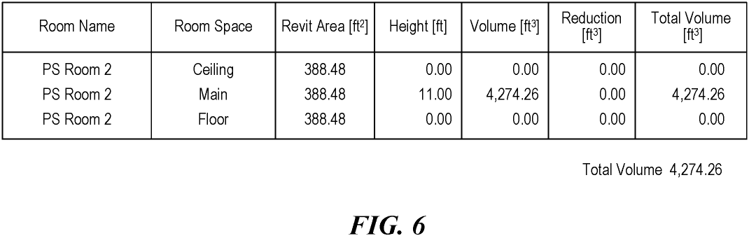

FIG. 6 illustrates example parameters of a room to be protected from fire. For example, FIG. 6 shows a room name, a type of the room, dimensions of the room, a floor area associated with the room, and a volume associated with the room. In some fire protection designs, a reduction parameter shown in FIG. 6 can account for areas/portions of the room where protection may not be needed. The effective volume to be protected is the reduction volume subtracted from the original volume associated with the room. In some implementations, structural elements may be present in the room to be protected. Thus, the effective volume is preferably computed as the volume occupied by the structural elements subtracted from the original (actual) volume of the room. For example, if the dimensions of a room to be protected are 10 ft × 10 ft × 10 ft and the dimensions of a structural element in the room are 10 ft × 10 ft × 1 ft, then the effective volume to be protected is 900 cubic ft. It will be understood that volume reduction is optional and may not be implemented in designing some fire suppressant systems.

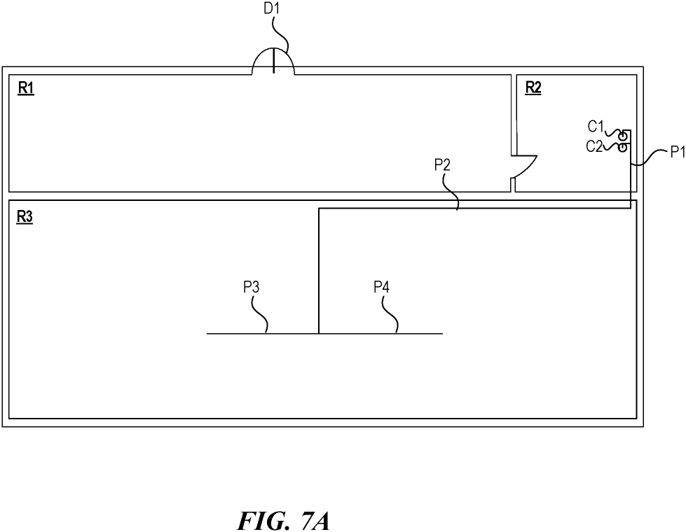

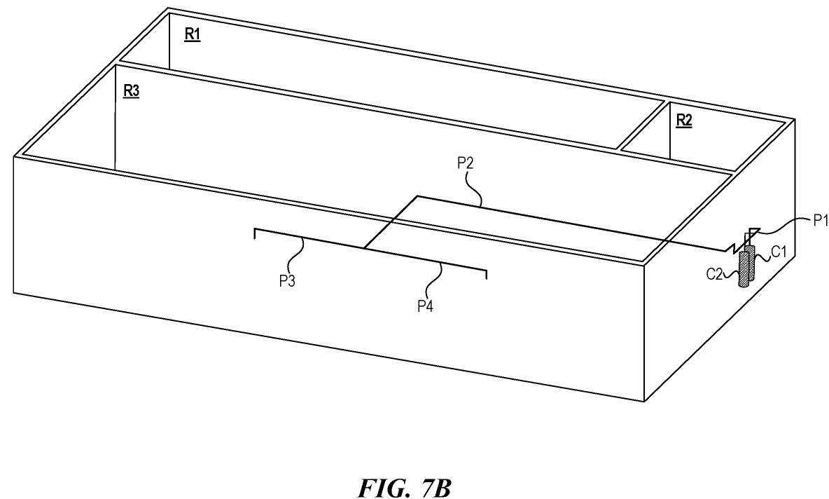

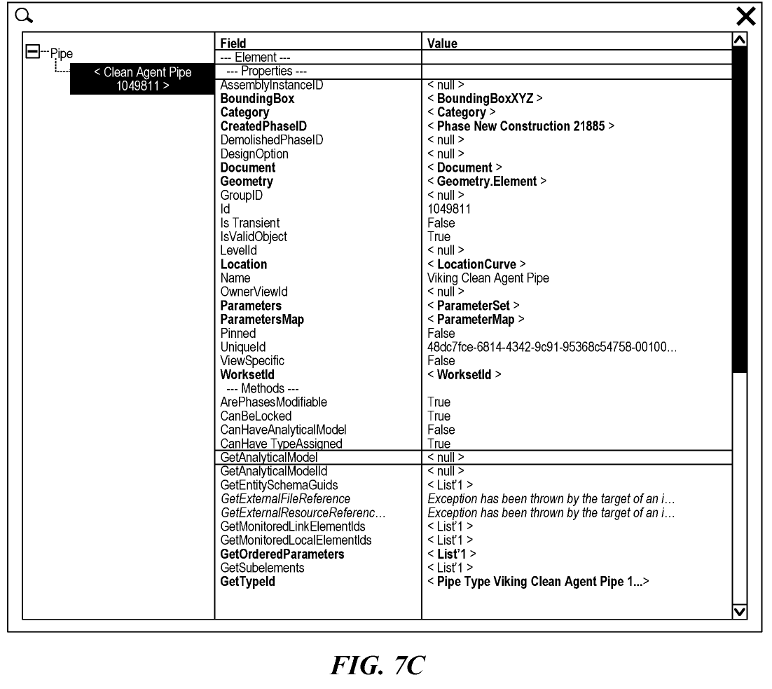

FIGS. 7A and 7B illustrate example views of a pipe network drawn using CAD software. The pipe network includes components which are preferably represented in a computer as data structures (e.g., objects). For example, in the visual layout shown in FIG. 7A, the room to be protected from fire is room 3 (denoted R3). Room 1 (denoted R1) is an adjacent room having an outward opening door (denoted D1). Room 2 (denoted R2) is preferably a room located near Room 3. Room 2 houses the fire suppressant agent cylinders and other pipe network components. Upon detecting a fire, fire suppressant agent is discharged from the cylinders (denoted C1, C2) in room 2 and travels via pipes P1, P2, P3, and P4 of the pipe network to fill the volume in room 3. It will be understood that the pipe network components in FIG. 7A can include other components (besides pipes P1, P2, P3, P4) which are not labeled in FIG. 7A. FIG. 7B illustrates a different view of the layout shown in FIG. 7A.

FIG. 7C illustrates an example database entry for a pipe associated with the pipe network diagram shown in FIGS. 7A and 7B. The database entry can identify various properties and characteristics of the pipe which is preferably used for computationally processing the pipe network. For example, some of the properties and characteristics are entered as input parameters by a designer or a fire protection professional. Furthermore, some of the properties and characteristics can include information obtained from manufacturer’s specifications or compliance standards. By processing the properties and characteristics of the pipe, disclosed embodiments can generate information relating to a pipe network, or otherwise trace a pipe network. It will be appreciated that the database entry in FIG. 7C is in the form of a multi-element configuration which is preferably used to represent a pipe network component (such as a pipe, an elbow, a tee, or any other component of a pipe network) in a computer model. When a designer updates or makes changes to the inputs of the pipe network, the multi-element configuration stored in a database is revised or modified, and accordingly the computer model gets revised. It will be understood that the elements listed in FIG. 7C are merely for illustrative purposes. Various other attributes can be included as a part or element of a multi-element configuration of a pipe network component.

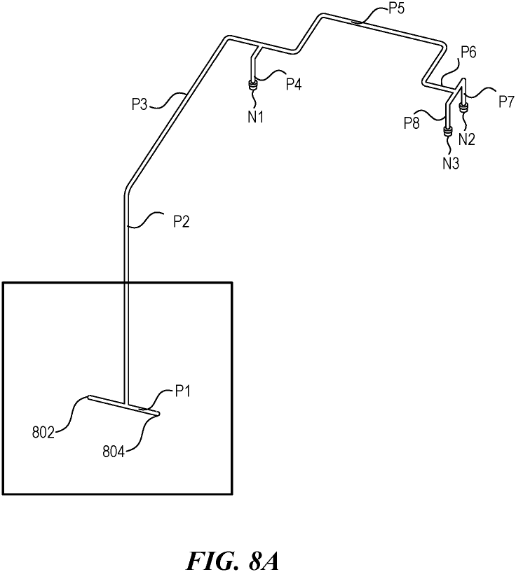

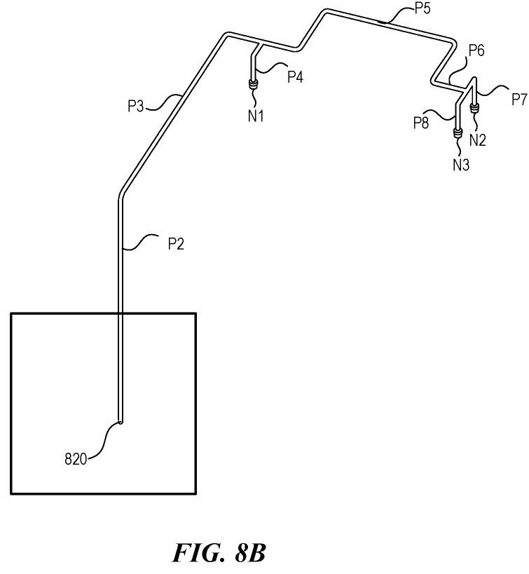

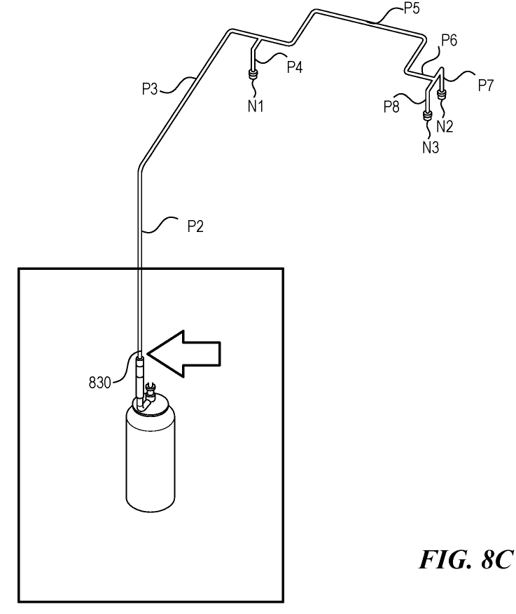

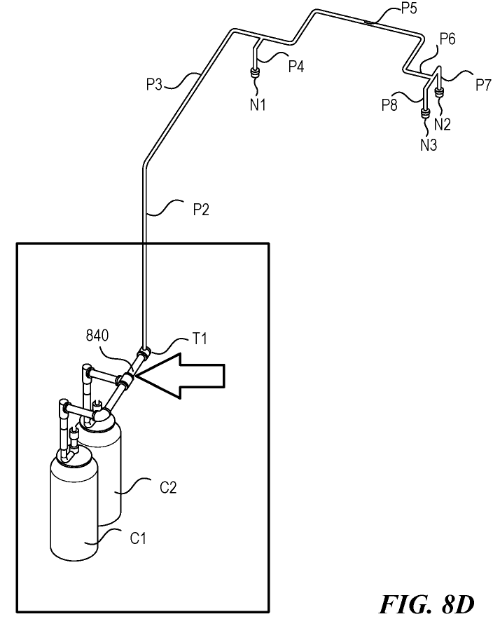

FIGS. 8A-8D are conceptual diagrams illustrating examples of origins of a pipe network. FIG. 8A shows a representative example of an open-ended pipe network with multiple open ends. The pipe network shown in FIG. 8A includes pipe components P1-P7 and nozzle components N1-N3. Nozzle components N1, N2, N3 are attached at the ends of pipe components P4, P7, P8 respectively. The supply end of a pipe network is regarded as the end of the pipe network connected to one or more cylinders storing fire suppressant agents. The supply end of the pipe network is preferably defined as the origin of the pipe network. Ends 802 and 804 of the pipe P1 are not connected to a container storing a fire suppressant agent and, therefore, the pipe network lacks supply of a fire suppressant agent. Thus, the pipe network In FIG. 8A is termed as an open-ended pipe network with multiple open ends. In some embodiments, upon detecting that the origin of a pipe network is open-ended with multiple open ends, the disclosed fire suppressant design assistant can generate an error message indicating the open-ended pipe network and/or having multiple open ends.

FIG. 8B shows a representative example of an open-ended pipe network with a single open end. The single end 820 of pipe P2 is not connected to a fire suppressant agent supply and thus the pipe network composed of pipe components P1-P7 and nozzle components N1-N3 is regarded as an open-ended pipe network with a single open end.

FIG. 8C shows a single cylinder attached to pipe P2 at one end of the pipe network including pipe components P1-P7, nozzle components N1-N3, and tee component T1. The origin of the pipe network is preferably defined as point 830 where the single cylinder attaches to the pipe network. The first pipe (denoted P2) in the pipe network is defined to be the pipe that is attached to the single cylinder. In other words, the first pipe of this pipe network is P2 and the origin of the pipe network is point 830.

FIG. 8D shows a cylinder bank (manifold) attached to pipe P2 at one end of the pipe network. The origin of the pipe network is preferably defined as point 840 where the cylinder bank attaches to the pipe network including pipe components P1-P7, nozzle components N1-N3, tee component T1, and cylinder bank including cylinders C1, C2. The first pipe (denoted P2) in the pipe network is defined to be the pipe beginning after the last tee (denoted T1) located on the cylinder bank including cylinders C1, C2. In other words, the first pipe of this pipe network is P2 and the origin of the pipe network is point 840.

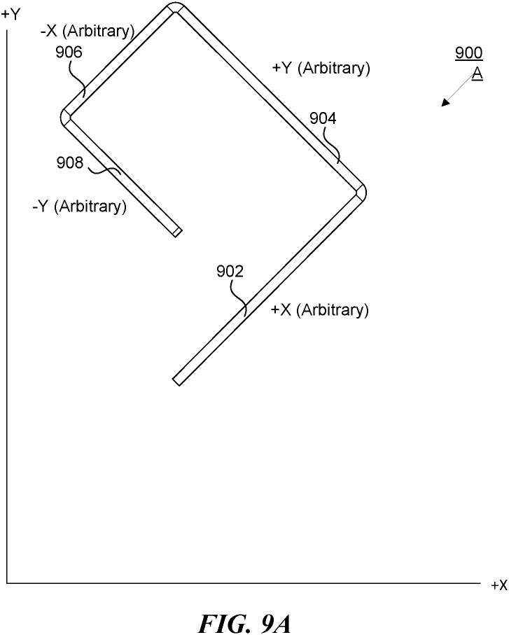

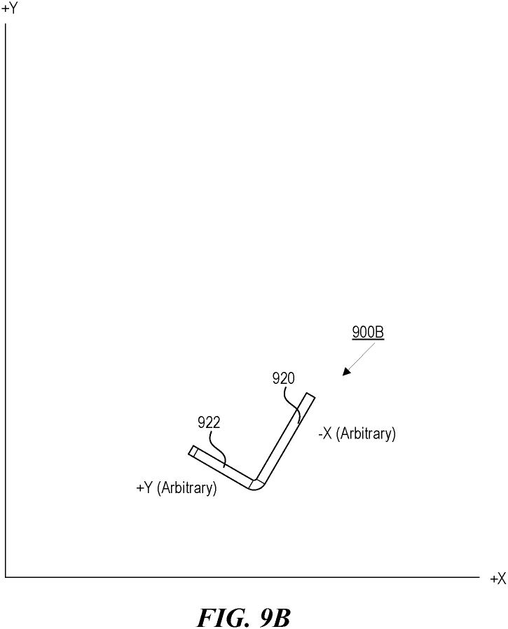

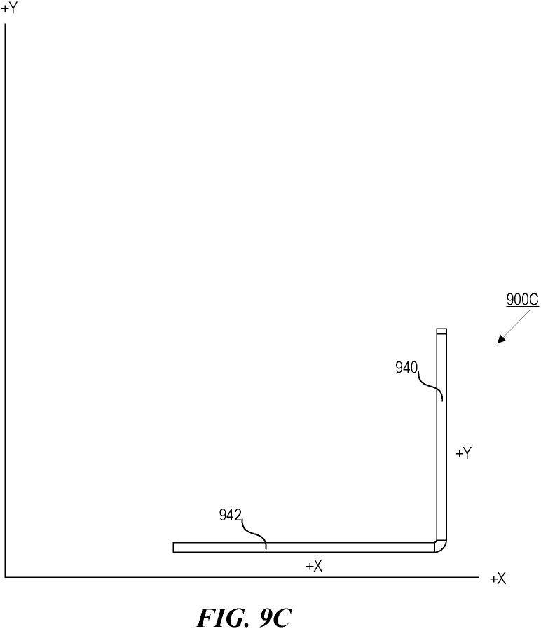

FIGS. 9A-9C are conceptual diagrams illustrating examples of directionalities of pipes in a pipe network. For example, FIGS. 9A and 9B show real-world orientations of pipes aligned along arbitrary X, Y, and Z axes. FIG. 9A shows pipes 902, 904, 906, and 908 connected respectively to one another via elbows. FIG. 9A shows X and Y axes with respect to a specified coordinate system. Although pipes 902, 904, 906, and 908 can be included in a real-world fire suppressant system, none of pipes 902, 904, 906, and 908 are aligned along the X or Y axis. Rather, pipes 902, 904, 906, and 908 are oriented in space in accordance with a coordinate system different from the X, Y coordinate axis system shown in FIG. 9A. For example, pipe 902 is oriented along an arbitrary +X direction. Pipe 904 is oriented along an arbitrary +Y direction. Pipes 906 and 908 are oriented along arbitrary -X and -Y directions, respectively. FIG. 9B shows example pipes 920 and 922 oriented along arbitrary -X and +Y directions in accordance with a coordinate system different from the X, Y coordinate axis system shown in FIG. 9B. FIGS. 9A and 9B show real-world orientations of pipes aligned along arbitrary X, Y, Z axes. FIG. 9C shows example pipes 940 and 942 connected to one another, and both pipes 940 and 942 are consistently aligned along one of X or Y coordinate axis shown in FIG. 9C. Thus, a normalized directionality of pipe 942 is computed as +X and a normalized directionality of pipe 940 is computed as +Y.

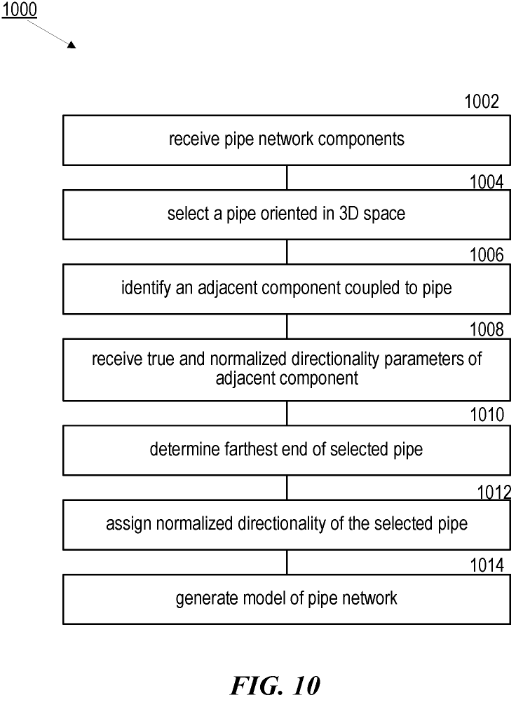

FIG. 10 is a flow diagram illustrating a process 1000 used in some implementations for computing a normalized directionality of a pipe, e.g., implemented by a pipe directionality analyzer module of a computing system. In many real-world scenarios, it is possible that a pipe does not conform to any one of the X, Y, Z coordinate axes in either positive or negative directions. For example, in a real-world scenario where one of the pipe network components is a cross, one or more pipes connected to the cross may or may not be aligned along one of the X, Y, Z coordinate axes, based on how the cross is oriented with respect to a 3D reference space. Process 1000 is preferably used to assign normalized directionality to pipes that are not aligned along one of the X, Y, or Z axes in either positive or negative directions. As a result of assigning a “normalized directionality,” the pipe is re-oriented (for purposes of representation in a computer model) along an axis of a specified set of axes (e.g., the pipe is re-oriented along one of the X, Y, or Z axes). Accordingly, the normalized directionality of a pipe is preferably one of: +X, -X, +Y, -Y, +Z, or -Z.

At block 1002, process 1000 receives indications of pipe network components that form a pipe network, with at least one of the components being a pipe. For example, the indications of pipe network components can be based on an component-by-component tracing of the pipe network. At block 1004, process 1000 selects a pipe that can be arbitrarily oriented in 3D space. That is, the pipe may or may not be aligned along one of defined X, Y, or Z axes in either positive or negative directions. At block 1006, process 1000 identifies an adjacent component coupled to the selected pipe. The adjacent component is preferably another pipe component spatially preceding (or, succeeding) the selected pipe in the pipe network. At block 1008, process 1000 receives information that identifies (a) a normalized directionality of the adjacent component, (b) a true (original) directionality of the adjacent component, and/or (c) a positional parameter defining one end of the adjacent component. In some implementations, the true directionality and the positional parameter can each be a set of 3-dimensional coordinates. For example, the normalized directionality of the adjacent component can be +X, the true directionality of the adjacent component can be (0.5, 0.5, 0), and the positional parameter of the adjacent component can be the coordinates (2, 1, 0).

At block 1010, process 1000 determines which end of the pipe is farthest from the adjacent component. For example, by comparing the ends of the pipe with the positional parameter, process 1000 can determine which of the two ends of the pipe is farthest from the adjacent component. The nearest end is designated as the first end and the farthest end is designated as the second end. In the present disclosure, an “end” of a pipe can correspond to a connector that represents (in a computer system) a virtual point referencing the end of the pipe. In some implementations, components of a pipe network can be represented with data structures (e.g., objects) in a computer system and a connector associated with a pipe component is preferably considered as a reference to the pipe component object.

In accordance with disclosed embodiments, for determining a directionality of a pipe selected with respect to an adjacent component, process 1000 determines (at block 1012) if there is a right angle between an adjacent component and the selected pipe. A right angle can indicate a presence of a fitting between the adjacent component and the pipe. For example, process 1000 initially checks if the pipe is oriented along the positive or negative Z axis. If process 1000 determines that the pipe is oriented along neither the positive Z axis nor the negative Z axis, then process 1000 determines whether the pipe is oriented along one of the +X, -X, +Y, or -Y axes. By accounting for positive or negative Z axis initially, process 1000 can determine if the pipe causes a rise or a drop in elevation. For example, if the pipe is oriented along +X, -X, +Y, or -Y, there are no changes in elevation along the (positive or negative) X or Y axes but pressure losses/rises due to the pipe and fittings attached to the pipe need to be accounted for. If the pipe is oriented along +Z or -Z, then pressure losses/rises due to the pipe and fittings attached to the pipe need to be accounted for in addition to pressure losses/gains due to elevation.

Upon determining which of the two ends of the pipe is farthest from the end of the adjacent component, process 1000 evaluates (at block 1012) the true directionality of the selected pipe and the relative change in X, Y, and Z directions between the positional parameter and the far end of the selected pipe. If the true directionality of the selected pipe is equal or close to (0, 0, 1) or (0, 0, -1), process 1000 assigns the normalized directionality of the selected pipe to be on the Z axis. To determine whether the Z axis is positive or negative, process 1000 determines whether the end of the adjacent component is above or below the end of the selected pipe. If the Z coordinate of the positional parameter (of the adjacent component) is less than the Z coordinate of the far end of the selected pipe, then the normalized directionality of the selected pipe is assigned as +Z. However, if the Z coordinate of the positional parameter (of the adjacent component) is greater than the Z coordinate of the far end of the selected pipe, then the normalized directionality of the selected pipe is assigned as -Z.

If the true directionality of the selected pipe is neither equal nor close to (0, 0, 1) or (0, 0, -1), process 1000 determines (at block 1012) that the selected pipe is aligned along neither +Z nor -Z. Thus, process 1000 evaluates the normalized directionality of the adjacent component. If the normalized directionality of the adjacent component is along +Z or -Z, then the normalized directionality of the selected pipe is determined to be along +X or -X.

However, if the normalized directionality of the adjacent component is along +X, -X, +Y, or -Y, then process 1000 compares the true directionality of the adjacent component and the selected pipe. If the result of the comparison indicates that the adjacent component is parallel to the selected pipe, then process 1000 determines that the normalized directionality of the selected pipe is the same as the normalized directionality of the adjacent component. For example, if the true directionality (e.g., based on its direction vector) of the adjacent component is (1, 0, 0) and the true directionality of the selected pipe is (1, 0, 0) or (-1, 0, 0), then process 1000 assigns the normalized directionality of the selected pipe as the normalized directionality of the adjacent component. It will be understood and appreciated that the true directionality of a pipe is dependent on how the pipe is drawn or otherwise placed relative to the positional parameter of the adjacent component. For example, in a use-case, if the positional parameter of the adjacent component is defined as (0, 0, 0) and the far end of a first pipe is defined as (1, 0, 0), then the true directionality (e.g., based on its direction vector) of the pipe is (1, 0, 0). If a second pipe connected to the first pipe is positioned between (2, 0, 0) and (1, 0, 0), then the true directionality of the second pipe is computed as (-1, 0, 0).

If the result of the comparison indicates that the adjacent component is not parallel to the selected pipe, process 1000 checks whether the true directionality of the selected pipe and the true directionality of the adjacent component are at right angles to one another. For example, if the normalized directionality of the adjacent component is +X, then process 1000 assigns the normalized directionality of the selected pipe as +Y. After determining whether the selected pipe is aligned along either the X or Y axis, the sign of the axis is evaluated based upon a respective comparison of the X and Y coordinates of the positional parameter and the far end of the selected pipe. That is, if the positional parameter defining one end of the adjacent component has an X coordinate value less than the X coordinate value of the far end of the selected pipe, process 1000 assigns the normalized directionality of the selected pipe as +X. Alternatively, if the positional parameter defining one end of the adjacent component has an X coordinate value greater than the X coordinate value of the far end of the selected pipe, process 1000 assigns the normalized directionality of the selected pipe as -X. Process 1000 applies a similar logic in determining whether the selected pipe is along +Y or -Y.

At block 1014, process 1000 can generate a computer model of the pipe network using the normalized directionality of the selected pipe. In some implementations, the normalized directionality can be used by another process such as a hydraulics computation process.

In some implementations, process 1000 can generate error messages in response to determining that angles or slopes of the selected pipe are invalid. For example, upon determining that the selected pipe does not align along the positive or negative Z axis, process 1000 can generate an error message indicating that attributes of the selected pipe are incorrect. As another example, upon determining that the selected pipe is not at right angles to the adjacent component, process 1000 can generate an error message. A designer viewing the error message is informed of incorrect attributes or invalid angles and take corrective action. In some implementations, the error message is displayed on the screen/monitor of a computing system in real time or near real time of execution of process 1000. In some embodiments, process 1000 can take corrective action itself (e.g., without input or feedback from the designer). Although the discussions in FIG. 10 are illustrated using pipe networks of a fire suppressant system, in alternate embodiments, these discussions apply to pipes included in other types of pipe networks.

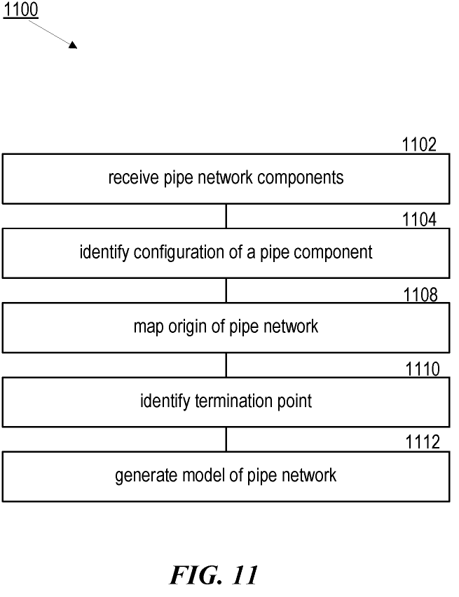

FIG. 11 is a flow diagram illustrating a process 1100 used in some implementations for tracing a pipe network e.g., implemented by a pipe network tracer module of a computing system. In some implementations, tracing a pipe network can include traversing or parsing a data structure associated with pipe network components. For example, the pipe network is preferably represented as a linked list and each component of the pipe network is preferably represented as an item in the linked list.

At block 1102, process 1100 receives indications of components (e.g., pipes, tees, elbows, reducers, sprinklers, couplings, and other components) arranged to form a pipe network, with at least one of the components being a pipe. For example, the indications of multiple pipe networks can be based on a component-by-component tracing of the pipe network. In some implementations, process 1100 can also receive one or more specifications of a real-world building such as dimensions of a floor or a zone where assets are to be housed and dimensions of rooms where supply cylinders and pipe network components are to be placed. At block 1104, process 1100 identifies a multi-element configuration of the pipe. For example, the multi-element configuration can identify dimensions, directionality, part numbers (IDs), a point of fire suppressant agent supply, and other attributes of information about the pipe. At block 1106, process 1100 maps the origin (e.g., a starting point or a supply point) of the pipe network, based on the multi-element configuration. For example, process 1100 can map the origin of the pipe network to one end of a cylinder supplying a fire suppressant agent. In such an example, the origin is marked or identified as the point where the first pipe is attached to the cylinder. As another example, process 1100 can map the origin to one end of a collection of cylinders supplying fire suppressant agents. In such an example, the origin of the pipe network is identified as the point where the first pipe begins after the last tee in the collection of cylinders. At block 1108, process 1100 maps a termination point of the pipe network. For example, the termination point can be a nozzle, a cap, or other terminating fittings. Based on the multi-element configuration, the origin, and/or the termination point, process 1100 generates (at block 1112) a computer model of the pipe network for fitting into a real-world building. In some implementations, process 1100 traverses the pipe network between the termination point and the origin to generate the model of the pipe network. The traversing of the pipe network can be one-directional or in multiple directions.

In some implementations, process 1100 can implement additional steps (e.g., at block 1108) to detect if one or more parameters of the pipe network are invalid. In some instances, an invalid parameter can lead to the pipe network model not getting mapped to a proper origin. Also, if the pipe network has multiple open ends, process 1100 can detect the multiple open ends and provide an error notification. A designer can accordingly take corrective action and provide revised inputs/indications that results in the multi-element configuration of the pipe network component getting updated or modified. Consequently, process 1100 can determine that ends of the pipe network are not indicated as open, or otherwise the origin of the pipe network does not map to multiple open ends.

In some implementations, process 1100 can implement additional steps to detect if one or more pipe network components are outside an allowed set of component categories included in a “whitelist.” Examples of allowed components are preferably a right-angled elbow, a tee, a coupling, a reducer, and a nozzle. For example, if process 1100 detects a wet pipe check valve on the pipe network, process 1100 can detect an error. A designer can accordingly take corrective action and provide revised inputs/indications that results in the multi-element configuration of the pipe network component getting updated or modified. Therefore, process 1100 can determine that none of the multiple pipe network components connected to the pipe component is outside the specified set of component categories.

In some implementations, process 1100 can implement additional steps to compute a pipe fitting length, or process 1100 can call another process that computes a pipe fitting length. A pipe fitting length is defined as a combined length including length of a pipe and a size of an attached fitting. If the fitting attached to a first pipe is a reducer or a coupling followed by a second pipe, then the pipe fitting length is a cumulative length defined as a sum of the length of the first pipe and a portion of the length of the reducer or the coupling. For example, if length of pipe 1 = 1 inch, length of pipe 2 = 1 inch, and length of the coupling = 0.1 inch, then the combined length of pipe 1 (or, equivalently, length of pipe section 1) is computed as 1.05 inches and the combined length of pipe 2 = 1.05 inches. Thus, the cumulative length uses a partial dimension) of the reducer or coupling.

According to disclosed embodiments, a pipe fitting length can be considered as one of multiple attributes of a pipe. Other examples of pipe attributes are preferably a directionality of a pipe, a part ID number of a pipe, a diameter of the pipe, a type of the pipe, a material used to manufacture the pipe, components or fittings that are allowed to be attached to the pipe, components or fittings that are exempted from attaching to the pipe, and other attributes. Attributes of the pipe are preferably used in defining a multi-element configuration of the pipe, which can be used in generating a pipe network model at block 1112. In some embodiments, the pipe attributes included in the multi-element configuration of the pipe is communicated to another module (e.g., a hydraulics calculation engine), which can be remotely located. It will be understood that attributes of pipe network components discussed herein are merely for illustration. Alternate embodiments of the disclosed technology can include any combination of these attributes, or other attributes.

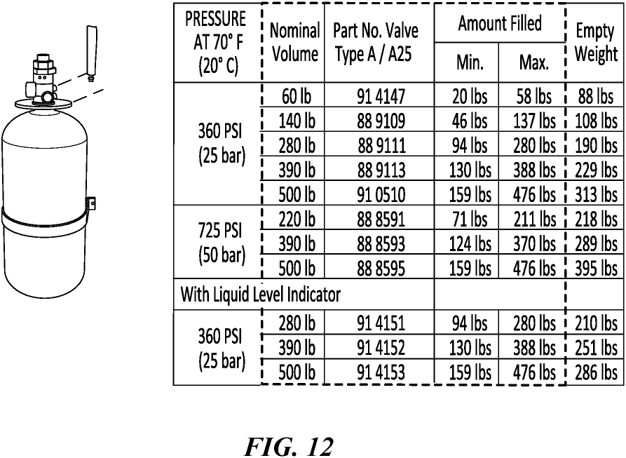

FIG. 12 is an example table showing parameters of cylinders storing fire suppressant agents. The table includes columns identifying a pressure, a nominal weight, a part number, a fillable weight, and an empty weight. The fillable weight of a cylinder is preferably defined by a minimum fillable weight and a maximum fillable weight. Typically, the nominal weight provides an approximate estimate of the weight of a cylinder. The table shows multiple options for containers. For example, with a nominal weight of 280 lbs, there can be two choices. A first choice includes a minimum weight of 94 lbs, a maximum weight of 280 lbs, and an empty weight of 190 lbs. A second choice includes a minimum weight of 94 lbs, a maximum weight of 280 lbs, and an empty weight of 210 lbs.

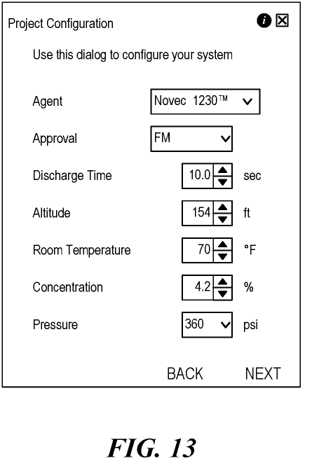

FIG. 13 illustrates example discharge parameters of a fire suppressant agent displayed on a dialog box of a GUI. Examples of physical and discharge parameters include a type of fire suppressant agent (e.g., Novec 1230™), a time taken to discharge the fire suppressant agent from a cylinder, a measure of concentration of the fire suppressant agent to be used in the room/volume to be protected, a room temperature, a pressure of the fire suppressant agent stored in the cylinder, an altitude (from mean sea level) of the room, and manufacturer’s specifications associated with a cylinder. In some implementations, the dialog box can include a drop-down with options for choosing a type of an approval, e.g., Underwriter Laboratories (UL) or Factory Mutual (FM). In some implementations, the disclosed fire suppressant design assistant uses default values of discharge parameters in determining container configurations that meet the designer’s specifications and/or manufacturer’s specifications.

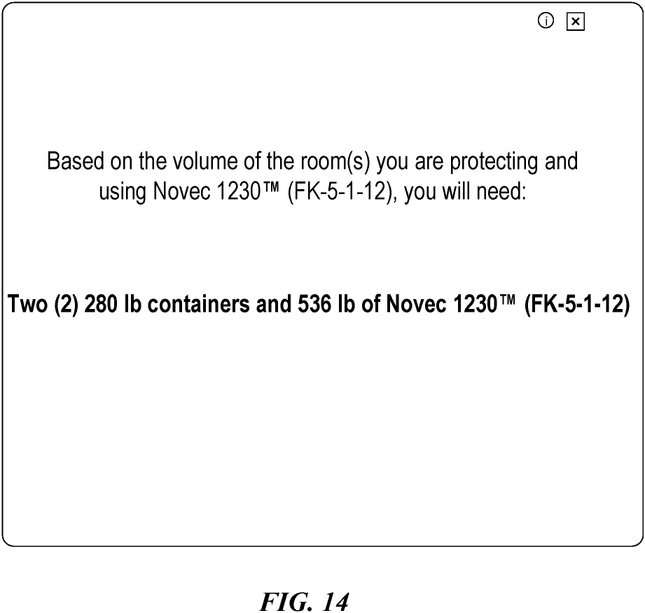

FIG. 14 illustrates an example container configuration of fire suppressant agents. For example, the example container configuration is preferably the output of a process for computing a fire suppressant agent container configuration. The output can be based on dimensions of the room to be protected and/or physical and chemical discharge parameters of the fire suppressant agents used in the design. FIG. 14 also shows a weight (e.g., in lb or kg) of a fire suppressant agent needed for fire protection.

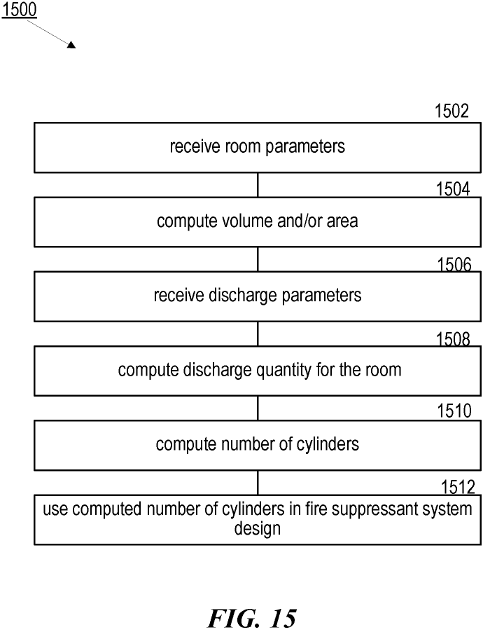

FIG. 15 is a flow diagram illustrating a process 1500 used in some implementations for computing a fire suppressant agent container configuration e.g., implemented by a cylinder configuration calculator module of a computing system. Fire suppressant agents can be of various types, e.g., water-based, gas-based, foam-based, etc. Further, fire suppressant agents can be stored in different-sized containers. Even further, a given container can store different weights of a fire suppressant agent. The fillable weight of a container storing a fire suppressant agent typically lies in between a minimum and a maximum value. Advantageously, process 1500 can be used to determine a configuration of containers that meets the designer’s specifications.

At block 1502, process 1500 can receive room parameters associated with a building where assets are to be protected. Room parameters can include dimension of the room where the assets are located. Additionally, room parameters can optionally include dimensions of one or more nearby rooms where the fire suppressant system (or, a portion thereof) will be placed. In some implementations, the room parameters are received from a CAD database (e.g., a REVIT® database). In some implementations, the room parameters are received from a fire suppressant system designer, e.g., in the form of a file upload or entered via a GUI. In some implementations, a portion of the room parameters are received from a CAD database and a remaining portion of the room parameters are received from a designer. For example, the room parameters received from the CAD database can only be a length, width, and height of a room without accounting for custom room features such as an attic or a false ceiling. Not accounting for such features in area and volume calculations can result in poorly designed fire suppressant systems. Thus, as an optional verification step, process 1500 can prompt the designer to request dimensions of ceiling space, subfloor, or additional features to be protected. Using the received room parameters, at block 1504, process 1500 computes a volume and/or a floor space area to be protected. At block 1506, process 1500 can receive physical and chemical discharge parameters of a fire suppressant agent for protecting the assets. For example, the physical and discharge parameters are preferably used to compute a weight of fire suppressant agent. Examples of physical and discharge parameters include a type of fire suppressant agent, a time taken to discharge the fire suppressant agent from a cylinder storing the fire suppressant agent at a specified pressure, a measure of concentration of the fire suppressant agent to be used in the room/volume to be protected, a room temperature, a pressure of the fire suppressant agent stored in the cylinder, an altitude (from mean sea level) of the room, and manufacturer’s specifications associated with a cylinder. For example, a designer can enter discharge parameters via a GUI associated with an embodiment of the disclosed fire suppressant agent. In some implementations, default discharge parameters are used. In some implementations, process 1500 retrieves the discharge parameters from a database (e.g., a CAD database).

Based on the room volume and the discharge parameters, process 1500 computes (at block 1508) a fire suppressant agent discharge quantity for the room. In some implementations, the discharge quantity (denoted W) for the room can be computed using the following formula (e.g., an equation from NFPA 2001 standard for halocarbon clean agent):

$$W = \frac{V}{S} \left(\frac{C}{100 - C}\right)$$

where:
w = fire suppressant agent discharge quantity for the room [lb],
v = net volume of hazard, calculated as the gross volume minus the volume of fixed structures impervious to clean agent vapor [ft³],
c = fire suppressant agent design concentration (vol %), and
s = specific volume of the superheated agent vapor at 1 atm and the minimum anticipated temperature [°F. (°C.)] of the protected volume [ft³/lb].

The net volume of hazard can be based on the volume of the room. The fire suppressant agent design concentration and the specific volume of the superheated agent vapor can be included in the discharge parameters and/or manufacturer’s specifications. At block 1510, process 1500 computes a number of cylinders storing fire suppressant agents. In some implementations, the number of fire suppressant agent cylinders can be computed based on the fire suppressant agent discharge quantity and dimensions of the fire suppressant agent cylinders using the formula:

$$N o . o f C y l i n d e r s = c e i l \left(\frac{W}{M F - R A}\right)$$

In the above equation, ceil (.) is the ceiling function, MF corresponds to the maximum fillable weight per cylinder, and RA denotes the residual volume amount left over from each cylinder after each cylinder is filled to its maximum fillable capacity. The parameter RA can be a constant value regardless of whether a cylinder is filled to its maximum capacity. For example, the parameter RA can depend on a type or geometry of a cylinder. The parameters MF and RA are related to dimensions of the fire suppressant agent cylinders and can be obtained from manufacturer’s specifications. Thus, a weight fillable per cylinder is preferably computed using the formula:

$$W e i g h t F i l l a b l e P e r C y l i n d e r = c e i l \left(\left(\frac{W}{N o . o f C y l i n d e r s}\right) + R A\right)$$

The computed weight fillable per cylinder (e.g., in lb or kg) lies between a minimum fire suppressant agent fillable weight per cylinder and a maximum fire suppressant agent fillable weight per cylinder, which are typically available from manufacturer’s specifications. In some implementations, a filling density corresponding to the computed weight fillable per cylinder lies between a minimum filling density and a maximum filling density.

Everything considered equal, smaller containers are more effective to provide cost savings. However, if the number of smaller containers exceeds the number of larger containers, then a small container configuration may not be effective. Hence, in some implementations, process 1500 can perform an optimization operation to determine the lowest number of containers in the smallest size. For example, if three 280 lb cylinders or three 390 lb cylinders are both acceptable cylinder configurations for fire protection, process 1500 can choose the configuration corresponding to three 280 lb cylinders. At block 1512, process 1500 can use the computed number of fire suppressant agent cylinders in designing a fire suppressant system for a building. Further, in some embodiments, process 1500 can determine whether a single-cylinder configuration or a multi-cylinder configuration (container bank) is better-suited for fire protection. In some embodiments, the feature of computing a fire suppressant agent container configuration is preferably implemented as a tool or a utility within a library of a BIM software such as REVIT®.

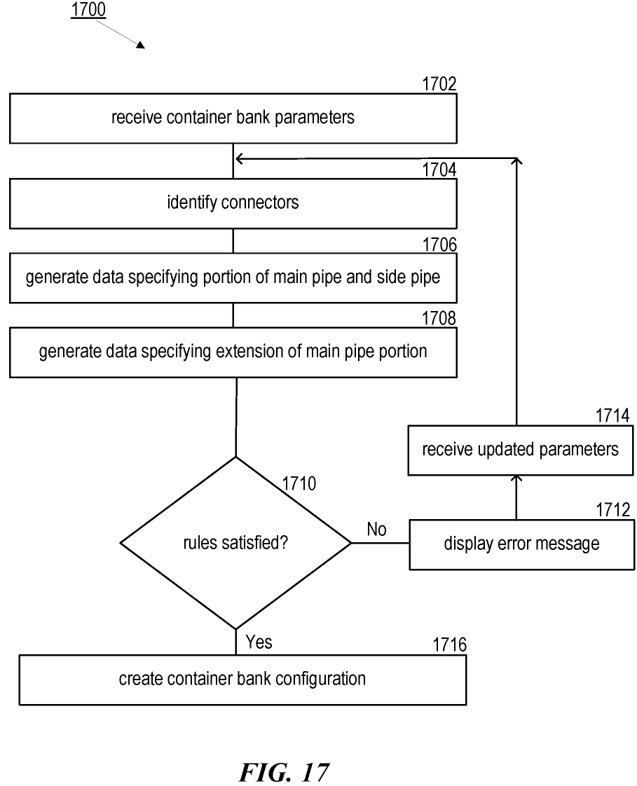

In some implementations, the fire suppressant agent container configuration generated by process 1500 can be used by another module (e.g., manifold generator 414 shown in FIG. 4) or method (e.g., process 1700 discussed in connection with FIG. 17) for creating data specifying a manifold, which can be either stored in a database for use in a computer model or used for visualization on a computer monitor.

In some implementations, process 1500 can apply an altitude correction factor to account for height above sea level. For example, the altitude correction factor can be applied to a room dimension (e.g., a height of a room) for computing the volume and area accurately. In some implementations, for -3000 ft to 5500 ft of equivalent altitude, the altitude correction factor Y can be expressed in terms of the altitude X as:

$$Y = \left(- 0.000036 \times X\right) + 1$$

In some implementations, for 5501 ft to 10,000 ft of equivalent altitude, the altitude correction factor Y can be expressed in terms of the altitude X as:

$$Y = \left(- 0.00003 \times X\right) + 0.96$$

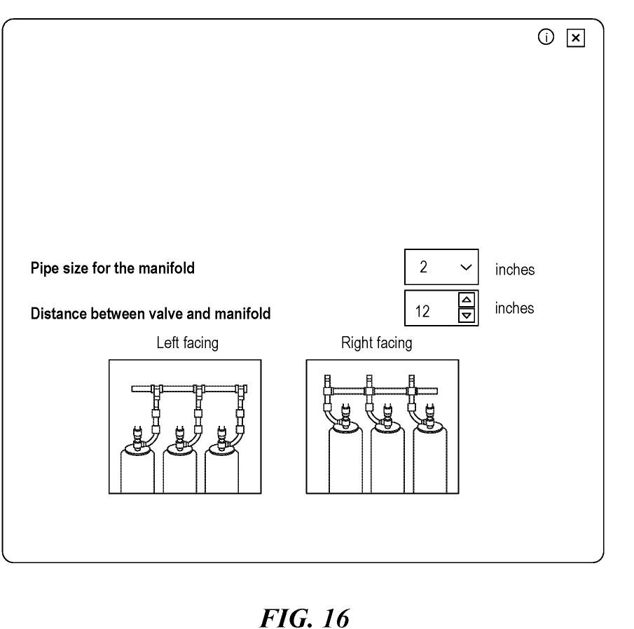

In alternate embodiments, the altitude correction factor is computed using other techniques such as a table lookup based on an altitude of the room. FIG. 16 illustrates examples of parameters defining a container bank configuration displayed on a dialog box of a GUI. For example, the container bank is preferably defined by a pipe size of the manifold and a distance between a valve and the manifold. A designer can enter the pipe size of the manifold and the distance between a valve and the manifold. Based on those parameters, the disclosed fire suppressant design assistant can generate data specifying a container bank. The dialog box also shows options for selecting a left-facing or a right-facing container bank.

FIG. 17 is a flow diagram illustrating a process 1700 used in some implementations for generating data specifying a manifold, or more particularly, generating data specifying several portions (e.g., a portion of a main pipe, a side pipe, an extension of the portion of the main pipe etc.) of a manifold. Process 1700 is preferably implemented by a manifold generator module (or, equivalently a manifold data generator module) of a computing system. A manifold is preferably defined as one or more main pipes commonly connected to the containers (cylinders) of a container bank. Dimensions of a manifold can be generated from a container bank configuration. The data specifying the manifold can be used to create a “manifold pipe type” for use in a CAD software like AUTODESK REVIT®. The manifold pipe type is compliant with pipes and fittings used in fire suppression systems. For example, the manifold pipe type can conform to Schedule 40 steel or Schedule 80 steel standards. The manifold pipe type preferably provides data to generate computer visualizations using appropriate dimensions such as spacings between pipes, spacings between containers, and container diameters. The dimensions can be pre-determined or selected by the designer in accordance with compliance standards.

At block 1702, process 1700 can receive parameters defining a container bank that includes a collection of containers for storing fire suppression agents. For example, the parameters are preferably a diameter of the main pipe, a length of the side pipe, a number of containers in the container bank, a volume of each container in the container bank, a unique identification label of each container in the container bank, a dimension of a container in the container bank, or a dimension of a transition fitting on the main pipe. Additionally, process 1700 can receive other parameters such as manufacturer’s specifications. At block 1704, process 1700 identifies a first connector and a second connector associated with containers in the container bank. At block 1706, process 1700 generates data specifying a portion of the main pipe between the first connector and the second connector and data specifying a side pipe between the first connector and the check valve closest to (or, perpendicular to) the last container. Conceptually, this would result in a section of the main pipe extending between the last container and the second-to-last container to be generated and also a side pipe between the check valve and the first connector to be generated. In some implementations, the first connector can be on the end of the main pipe that is closest to/vertically above the last container in the container bank. The second connector can be on the other end of the section of the main pipe such that the second connector is closest to/vertically above the second-to-last container in the container bank. At block 1708, process 1700 generates data specifying extension of the main pipe portion to a third connector. For example, the third container can be the first container in the container bank. Conceptually, the above steps would result in representations of the main pipe and N side pipes being generated, where N corresponds to the number of containers in the container bank (N ≥ 2). The direction of the main pipe can be based on verifying (from the generated data) that the main pipe is at right angles to the first side pipe and the last side pipe.

At block 1710, process 1700 verifies that the transition fittings attached to the main pipe are in accordance with rules associated with container bank parameters. For example, the rules can apply to specific types of pipe and/or specify the transition fittings that are allowed (e.g., elbows, tees, or reducers) to be included in the container bank. The rules can also specify which transition fittings are not allowed (e.g., 45s, couplers, or crosses) to be included in the container bank configuration. A rule can specify that each container storing a fire suppressant agent is required to have a check valve for compliance with one or more standards associated with designs of fire suppressant systems. Another rule can specify that a container storing a fire suppressant agent is required to meet specifications of pressure for compliance with one or more standards. As another example of a rule, a minimum distance of separation between containers storing fire suppressant agents, based on a diameter of the main pipe, can be specified. Accordingly, based on the rules, process 1700 can detect mismatches between the size of one of the transition fittings and the size of the main pipe. That is, process 1700 can verify that sizes of transition fittings and the main pipe are matching. Upon detecting a mismatch, at block 1712, process 1700 can display an error message indicative of the mismatch. A designer viewing the error message can be informed of mismatches or invalid transition fittings and take corrective action so that sizes between the transition fittings and the main pipe match. Consequently, at block 1714, process 1700 receives updated container bank parameters and the process resumes from block 1704. In some implementations, the error message is displayed on the screen/monitor of a computing system in real time or near real time of execution of process 1700.

In some implementations, process 1700 identifies containers in the container bank according to a label such as a part ID. For example, the part ID can be obtained from manufacturer’s specifications associated with containers in the container bank. Further, in some implementations, the rules associated with container bank parameters can be included in a lookup table stored in a database accessible by process 1700. The rules can pertain to manufacturer’s specifications and compliance standards.

In some implementations, generating the data specifying the main pipe and the side pipes is preferably performed in an iterative manner. At each step of the iteration, a sub-portion of the container bank configuration is generated. Multiple sub-portions are preferably combined to generate the overall container bank configuration (which includes the manifold).

At block 1716, process 1700 creates a container bank configuration using the multiple sub-portions iteratively generated. In some implementations, the output of process 1700 is preferably a data structure of the fire suppressant agent container bank configuration corresponding to a REVIT® family instance that can be used to generate computer models or visualizations. A manifold is a main pipe commonly connected to the containers (cylinders) of a container bank. A computer model or visualization of the manifold is generated, which can be used in designing fire suppressant systems or as part of other systems. In some embodiments, the output of process 1700 can be used by another module or process to estimate a number of nozzles associated with the container bank configuration. Further, after the number of nozzles are calculated, a user can visualize the container configuration and the nozzles as a computer visualization. For example, a user can draw on a computer monitor to connect pipes between the cylinders and nozzles.

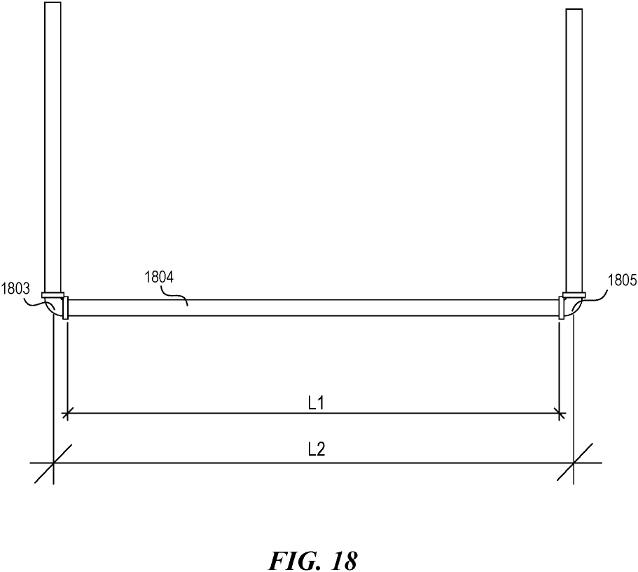

FIG. 18 is a conceptual diagram illustrating an example of a pipe fitting length. Two ends of pipe 1804 are attached to elbows 1803 and 1805. Pipe 1804 has a representative length (denoted L1 in FIG. 18) of 6' 9". Elbows 1803 and 1805 are 1 inch long with a 0.5-inch distance from each end to their respective geometrical centers. Thus, the pipe fitting length (denoted L2 in FIG. 18) of pipe 1804 is computed as 6' 9" + 0.5"+ 0.5" = 6' 10".

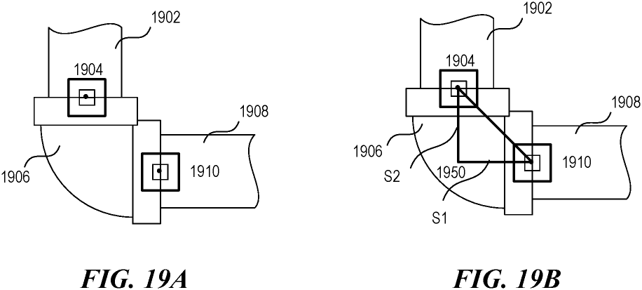

FIGS. 19A and 19B are conceptual diagrams illustrating calculations of pipe fitting length. Pipes 1902 and 1908 are attached to elbow 1906 at two ends of elbow 1906. Connectors 1904 and 1910 are located at two ends of elbow 1906. It will be appreciated from the drawings that at least one end of pipe 1902 and pipe 1908 is angled (e.g., at 90 degrees) with respect to the other end.

FIG. 19B shows straight lines beginning from connectors. For example, a first straight line beginning at connector 1910 and a second straight line beginning at connector 1904 intersect at point 1950 in the interior of elbow 1906. The portion of the first straight line between connector 1910 and intersection point 1950 is termed as segment 1 (denoted S1) in FIG. 19B. The portion of the second straight line between connector 1904 and intersection point 1950 is termed as segment 2 (denoted S2) in FIG. 19B. The first straight line can be parallel to a horizontal axis of elbow 1906 and the second line can be parallel to a vertical axis of elbow 1906. Connectors 1904, 1910, the first straight line, the second straight line, and intersection point 1950 are imaginary (conceptual) constructs for purposes of representing geometrical properties of elbow 1906 in a computer system. The pipe fitting length of pipe 1908 is preferably computed as the sum of the length of pipe 1908 and the length of segment 1. The pipe fitting length of pipe 1902 is preferably computed as the sum of the length of pipe 1902 and the length of segment 2.

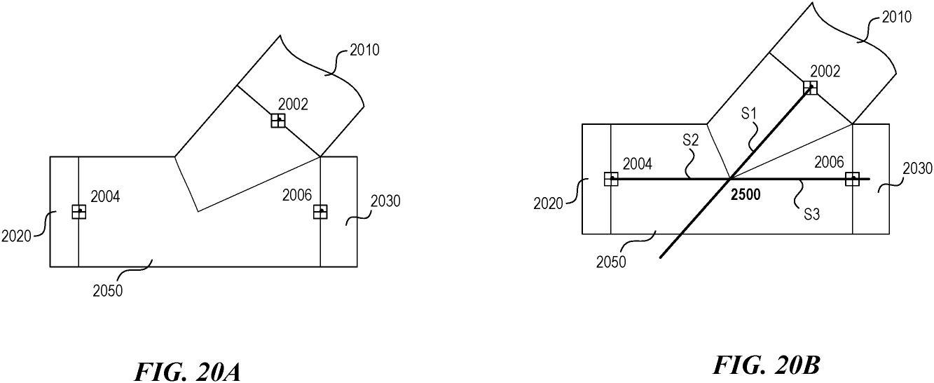

FIGS. 20A and 20B are conceptual diagrams illustrating calculations of pipe fitting length for a wye splitter fitting, with straight line segments denoted S1, S2, and S3. It will be appreciated from the drawings that at least one open end of pipe 2020, pipe 2010, and pipe 2030 is angled with respect to the other end(s) of the respective pipes.

Wye splitter 2050 is connected to pipes 2010, 2020, and 2030 at three ends. Connectors 2002, 2004, and 2006 are located at three ends of wye splitter 2050.

FIG. 20B shows straight lines beginning from connectors and meeting inside wye splitter 2050. For example, a first straight line beginning from connector 2002, a second straight line beginning from connector 2004, and a third straight line beginning from connector 2006 intersect at point 2500 in the interior of elbow wye splitter 2050. The first straight line can be parallel to an axis of wye splitter 2050 that passes through connector 2002. The second straight line can be parallel to an axis of wye splitter 2050 that passes through connector 2004. The third straight line can be parallel to an axis of wye splitter 2050 that passes through connector 2006. The portion of the first straight line between connector 2002 and intersection point 2500 is termed segment 1 (denoted S1). The portion of the second straight line between connector 2004 and intersection point 2500 is termed as segment 2 (denoted S2). The portion of the third straight line between connector 2006 and intersection point 2500 is denoted as segment 3 in FIG. 20B. Connectors 2002, 2004, 2006, the first straight line, the second straight line, and intersection point 2500 are imaginary (conceptual) constructs for purposes of representing geometrical properties of wye splitter 2050 in a computer system. The pipe fitting length of pipe 2010 can be computed as the sum of the length of pipe 2010 and the length of segment 1. The pipe fitting length of pipe 2020 can be computed as the sum of the length of pipe 2020 and the length of segment 2. The pipe fitting length of pipe 2030 can be computed as the sum of the length of pipe 2030 and the length of segment 3. Thus, depending on which of the three pipes is processed, the pipe fitting length of the pipe can be different. Although the descriptions in FIGS. 19A and 19B and FIGS. 20A and 20B are discussed from fittings with two ends and three ends, respectively, in alternate embodiments, the disclosed technique of computing the pipe fitting length is applicable to fittings with any number of open ends. For example, the disclosed technique can be applicable to a cross with four open ends.

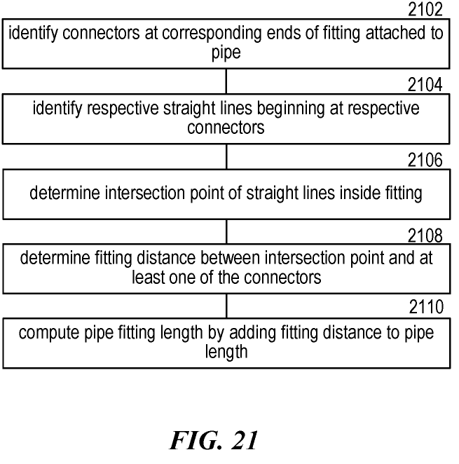

FIG. 21 is a flow diagram 2100 illustrating a process used in some implementations for computing a pipe fitting length, e.g., implemented by a pipe fitting length module of a computing system. In many instances, the actual length of a pipe (alternatively termed herein as pipe component) has to be modified to account for dimensions of fittings attached to the ends of the pipe. One such example can be in fire protection hydraulics, in which the hydraulics calculations typically ignore the elbow or other fitting attached to a pipe. Thus, in such instances, the actual length of the pipe is replaced by a pipe fitting length that includes dimensions of fittings attached to the pipe.

At block 2102, process 2100 identifies connectors located at ends of a fitting (e.g., a tee, an elbow, or a wye) attached to the pipe. At block 2104, process 2100 identifies straight lines beginning at respective connectors, e.g., in a direction parallel to an axis (such as the principal axis) of the fitting and toward the interior of the fitting. At block 2106, process 2100 determines an intersection point inside the fitting where the straight lines, beginning at the connectors, meet. The straight lines can be lines oriented in 3D space. At block 2108, process 2100 determines a fitting distance between the intersection point and the connector located at the end where the fitting attaches to the pipe. There can be a fitting distance corresponding to each end of the fitting. The straight lines and the intersection point are virtual for purposes of representing geometrical properties of physical pipe components in a computer system. At block 2110, process 2100 adds the fitting distance to a pipe length to compute the pipe fitting length. As such, the pipe fitting length computation for the pipe incorporates the dimensions of the fitting. In some implementations, process 2100 can also add a thread length of the fitting to the pipe fitting length. For example, the thread length can be obtained from manufacturer’s specifications. In some embodiments, a pipe can be represented in a computer model by a multi-element configuration. In those embodiments, the (actual) pipe length can be one of the attributes in the multi-element configuration of the pipe. To ensure that the dimensions of the pipe are accurate in the computer model, in those embodiments, the multi-element configuration of the pipe can be modified/updated with the (true) pipe fitting length of the pipe.

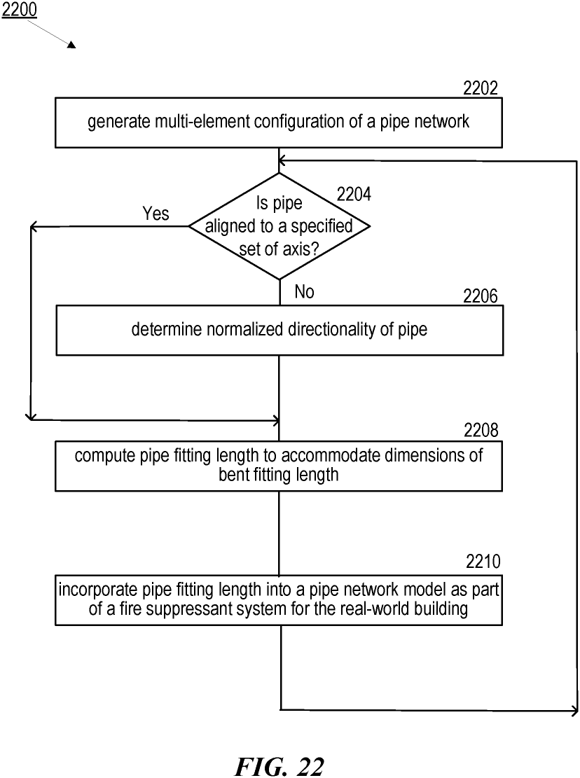

FIG. 22 is a flow diagram illustrating a process 2200 used in some implementations for generating a pipe network model. At block 2202, process 2200 can generate a multi-element configuration of a pipe network. (In some implementations, generating a multi-element configuration of a pipe network can be performed using process 1100.) The multi-element configuration can include dimensions, orientations, information identifying components attached to the pipe, etc., for one or more pipe network components. At block 2204, process 2200 can determine whether a pipe from the pipe network pipe is oriented along an axis in a specified set of axes. The axis can be one of defined X, Y, or Z axes. If process 2200 determines that the pipe is aligned along an axis, then process 2200 enters block 2208. If process 2200 determines that the pipe is not aligned along an axis, then process 2200 enters block 2206. At block 2206, process 2200 can determine a normalized directionality of the pipe. Determining a normalized directionality results in the pipe getting re-oriented along one of the X, Y, or Z axes in the computer-generated pipe network model. (In some implementations, determining a normalized directionality of a pipe can be performed using process 1000.) At block 2208, process 2200 can compute a pipe fitting length by combining the length of the pipe and dimensions of a fitting attached to the pipe. (In some implementations, computing a pipe fitting length of a pipe attached to a fitting can be performed using process 2100.) At block 2210, process 2200 can incorporate the pipe fitting length and the normalized directionality of the pipe into a computer model of the pipe network for use in designing a fire suppressant system for a real-world building. After executing block 2210, process 2200 loops back to block 2204 to select a next pipe in the pipe network to analyze. The loop ends when all components of the pipe network are analyzed.

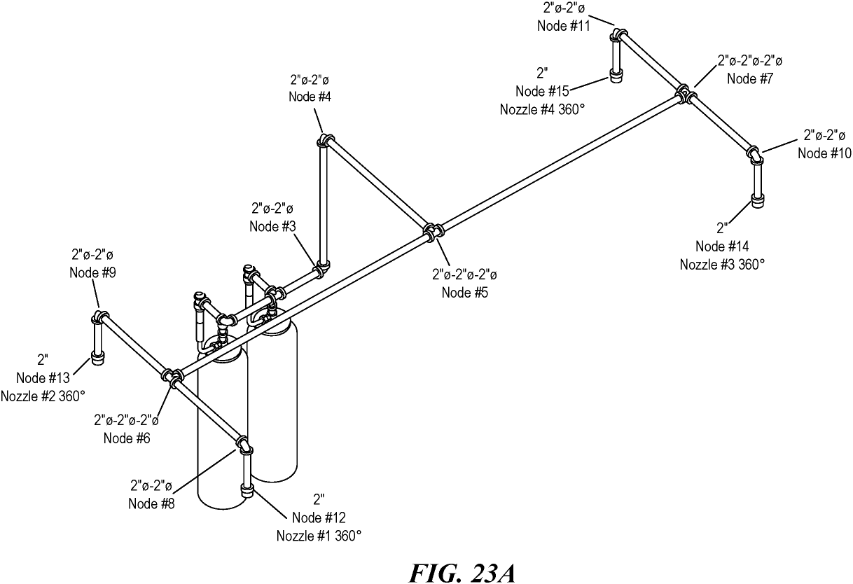

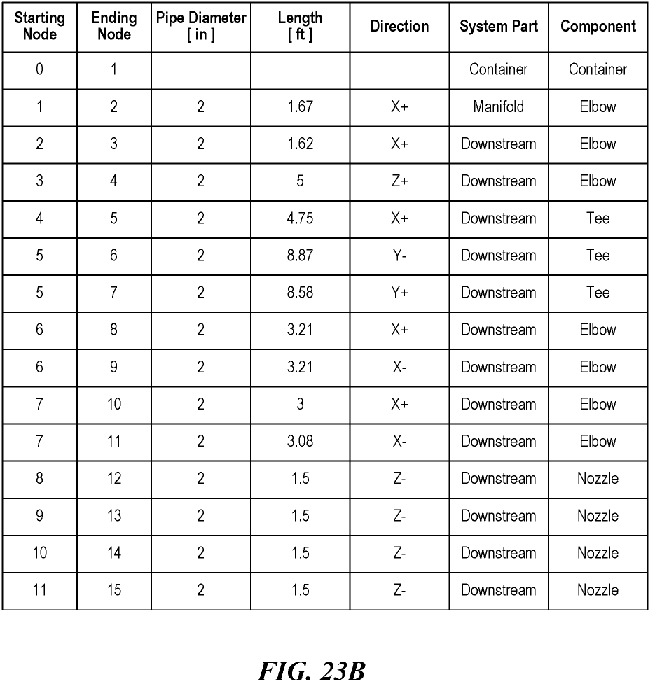

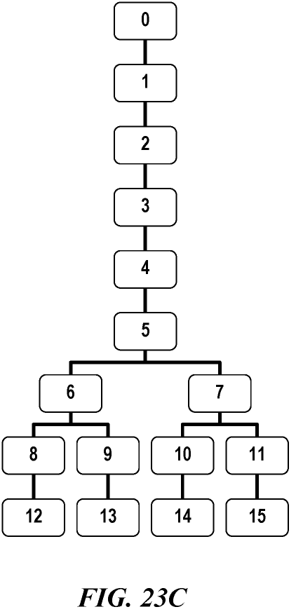

FIGS. 23A-23C are conceptual diagrams illustrating a representation of a pipe network model. For example, FIG. 23A shows pipe network components represented as nodes of a network with each node identified with a node number (or, ID) and associated dimension(s). For example, node #3, node #4, node #5 are elbows, with each elbow having a 2 inch diameter on either side. Node #12, node #13 are nozzles, each with a 2 inch diameter and capable of discharging a fire suppressant agent in a circular pattern (denoted 360-degrees in FIG. 23A). Node # 6, node #7 are tees, each tee having a 2 inch diameter on all three of its sides. The representative pipe network model in FIG. 23A can correspond to a real-world configuration or arrangement of the pipe network. Additional details of the nodes shown in FIG. 23A are discussed in connection with FIG. 23B.

FIG. 23B shows an example configuration of how the pipe network in FIG. 23A is preferably stored and/or represented in a computing environment/system. For example, FIG. 23B shows a table including various attributes, parameters, dimensions, and/or properties of the nodes in FIG. 23A. Thus, it will be appreciated that the electronic representation of the pipe network preferably provides information for storage in a database coupled to a computing system. FIG. 23C shows a visual representation (e.g., in a tree-like format) of the representative pipe network of FIG. 23A. The tree-like format can be beneficial in representing a pipe network as a connection diagram showing how nodes are numbered and connected to one another.

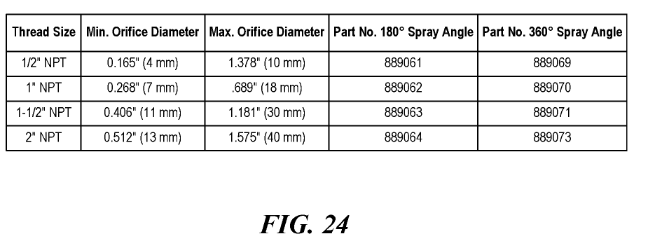

FIG. 24 is a table illustrating examples of discharge parameters of a nozzle configured to discharge a fire suppressant agent into a room or an area. The discharge parameters are preferably computed by a hydraulics module coupled to the disclosed fire suppressant design assistant. Examples of discharge nozzle parameters can be a minimum orifice diameter of a nozzle, a maximum orifice diameter of a nozzle, a thread size of a nozzle, and part numbers for 180-degree and 360-degree spray patterns of a nozzle. Because flow parameters can be installation-specific, the hydraulics module can compute flow parameters associated with each fire suppressant system designed.

In some embodiments, the hydraulics module can receive (as input) discharge parameters of a fire suppressant agent, a pipe network model, types of pipe (Schedule 40 or Schedule 80) included in the pipe network, normalized directionalities of pipes included in pipe network (e.g., computed by pipe directionality analyzer), room configuration parameters corresponding to the space to be protected, nominal dimensions of nozzles and associated weight proportions/percentages of fire suppressant agent configured to be discharged from a nozzle, and a configuration of supply cylinders storing fire suppressant agents. The hydraulics module can use the inputs to compute (as output) flow parameters of nozzles configured to discharge the fire suppressant agent. Examples of flow parameters of the fire suppressant agent are preferably a flow rate in each pipe of the pipe network, a starting pressure at each pipe of the pipe network, an ending pressure at each pipe of the pipe network, a pressure at each nozzle of the pipe network, a weight of fire suppressant agent discharged at each nozzle of the pipe network, a discharge time of a fire suppressant agent from a nozzle, a runtime for a nozzle, a vaporization length of a nozzle, an orifice diameter associated with a nozzle in the pipe network, and other parameters. In some embodiments, the hydraulics module uses the flow parameters in computing changes in pressure as the fire suppressant agent flows through the pipe network from a source (e.g., one or more supply cylinders) to a termination point (e.g., a nozzle). For example, the change in pressure can arise due to friction encountered by the fire suppressant agent through different lengths of pipes in the pipe network, different fittings attached to the pipe, elevation changes based on different directionalities of pipes in the pipe network, etc. Examples of configuration of supply cylinders storing fire suppressant agents are preferably a nominal size of a supply cylinder, a number of fire suppressant agent cylinders (e.g., computed by a cylinder configurator selector), a pressure of fire suppressant agent stored in a supply cylinder, a type of pipe network component (such as a flex hose or a swivel adaptor) connected to a supply cylinder, etc.

In addition to computing flow parameters associated with a fire suppressant agent, in some embodiments, the hydraulics module can perform validations of multiple attributes of the fire suppressant system design generated by the fire suppressant design assistant. Some validations can include re-validations of attributes validated by the fire suppressant design assistant. For example, the hydraulics module can re-validate that a cross fitting is not included as a component of the pipe network. Some validations of the hydraulics module can be new validations, e.g., not validated by the fire suppressant design assistant.

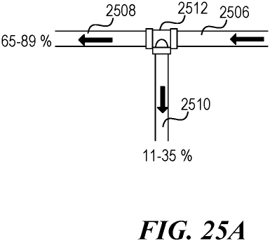

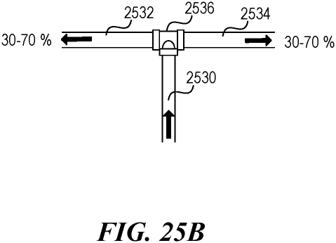

FIG. 25A is a conceptual diagram illustrating an example of proportions of fluid flow through pipes attached to a first tee fitting. For example, FIG. 25A shows a regular tee fitting 2512 connected to pipe 2508, pipe 2506, and pipe 2510. FIG. 25A shows allowable ranges of proportion (percentage) of fire suppressant agent flowing through pipe 2508 and pipe 2510, after entering tee fitting 2512 through pipe 2506. In some embodiments, the hydraulics module validates that the proportions in each direction of the flow of the fire suppressant agent are in accordance with manufacturer’s specifications. For example, the proportions (e.g., in the 65-89% range horizontally left though pipe 2508 and 11-35% range vertically down through pipe 2510) of fire suppressant agent flows illustrated in FIG. 25A are determined to be acceptable/valid by the hydraulics module. In some embodiments, the proportions or ranges of proportions are predetermined parameters.

FIG. 25B is a conceptual diagram illustrating an example of proportions of fluid flow through pipes attached to a second tee fitting. For example, FIG. 25B shows a bull tee fitting 2536 connected to pipe 2532, pipe 2534, and pipe 2530. FIG. 25B shows allowable ranges of proportion (percentage) of fire suppressant agent flowing through pipe 2532 and pipe 2534, after entering bull tee fitting 2536 through pipe 2530. In some embodiments, the hydraulics module validates that the proportions (e.g., distributed in the 30-70% range though each of respective pipes 2532 and 2534 horizontally left and right) in each direction of the flow of the fire suppressant agent are in accordance with manufacturer’s specifications. The proportions of fire suppressant agent flows illustrated in FIG. 25B are determined to be acceptable/valid by the hydraulics module. The proportions of fire suppressant agent flows in various pipes of a pipe network are preferably predetermined parameters to the hydraulics module.

Embodiments of the technology disclosed herein relate to the design of a fire suppressant system that can be installed in a real-world facility. In some implementations, the features and functionalities associated with designing a complete fire suppressant system (or, a portion thereof) are preferably implemented as a tool or a wizard integrated into a software library of a BIM software. The wizard can walk a fire protection professional (or, generally a user) through the necessary design steps including calculating the amount of agent and supply cylinders, auto-generating a manifold, placing nozzles, and drawing a pipe network of a computer model of the fire suppressant system. At the end of the fire suppressant system design process, a detailed project summary report is provided including all calculation outputs and a complete bill of materials for the designed fire suppressant system. Further, the designed fire suppressant system are preferably saved as a computer model on a computer-readable medium (such as disk storage) in case the user wishes to make changes to the fire suppressant system.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” or “embodiments” (e.g., “some implementations,” “various implementations,” “one implementation,” “an implementation,” “some embodiments,” “various embodiments,” “one embodiment,” “an embodiment,” etc.) means that a particular feature, structure, or characteristic described in connection with the implementation or embodiment is included in at least one aspect of the disclosure. The appearances of these phrases in various places in the specification are not necessarily all referring to the same implementation or embodiment, nor are separate or alternative implementations or embodiments mutually exclusive of other implementations or embodiments. Moreover, various features are described which may be exhibited by some implementations or embodiments and not by others. Similarly, various requirements are described which may be requirements for some implementations or embodiments but not for other implementations or embodiments.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

1-17. (canceled)

18. A computing system for automating design of a fire suppressant system, the computing system comprising:
one or more processors; and
a memory storing instructions that, when executed by the one or more processors, cause the computing system to perform operations for automatically determining aspects of a fire suppressant agent container bank configuration, the operations comprising:
receiving parameters defining a container bank that includes a plurality of containers storing fire suppressant agents;
identifying a first connector and a second connector associated with the container bank;
based at least in part on the parameters defining the container bank:
generating data specifying a portion of a main pipe extending between the first connector and the second connector;
generating data specifying a side pipe extending between the first connector and a check valve outlet in the container bank; and
generating data specifying an extension of the portion of the main pipe to a third connector;
verifying that transition fittings connected to the main pipe in the container bank are in accordance with one or more rules associated with the parameters defining the container bank; and
creating the fire suppressant agent container bank configuration to include the main pipe, the side pipe, and the transition fittings.

19. The system of claim 18, wherein the parameters defining the container bank include three or more of: a diameter of the main pipe, a length of the side pipe, a number of containers in the container bank, a volume of each container in the container bank, a unique identification label of each container in the container bank, a dimension of a container in the container bank, or a dimension of a transition fitting on the main pipe.

20. The system of claim 19, wherein the transition fitting is a tee and wherein the dimension of the transition fitting includes a diameter of the tee.

21. The system of claim 19, wherein the transition fitting is an elbow, and wherein the dimension of the transition fitting includes a diameter of the elbow.

22. The system of claim 18, wherein the first connector is associated with a last container in the container bank, the second connector is associated with a second-to-last container in the container bank, and the third connector is associated with a first container in the container bank.

23. The system of claim 18, wherein the check valve outlet in the container bank is associated with a last container in the container bank.

24. The system of claim 18, wherein the check valve outlet is included in a plurality of check valve outlets in the container bank, wherein generating the data specifying the extension of the portion of the pipe to the third connector includes generating the data specifying each side pipe between each check valve outlet in the container bank to an associated open end of the portion of the main pipe.

25. The system of claim 24, wherein a closed end corresponding to the open end of the portion of the main pipe is located vertically to the check valve outlet in the container bank.

26. The system of claim 18, wherein the one or more rules associated with the parameters defining the container bank are included in a table associated with a specific pipe type, and wherein the one or more rules specify the transition fittings allowed to be attached with the specific pipe type.

27. The system of claim 18, wherein the one or more rules include at least one rule configured for detecting a mismatch between a size of one of the transition fittings and a size of the main pipe.

28. The system of claim 27, wherein the operations further comprise:
in response to detecting the mismatch by applying the at least one rule configured for detecting the mismatch, displaying, by the computing system, an error message indicative of the mismatch;
receiving updated parameters defining the container bank; and
verifying, by applying the at least one rule configured for detecting the mismatch to the updated parameters defining the container bank, that sizes of the transition fittings and the main pipe match.

29. The system of claim 18, wherein the one or more rules pertain to parameters of the container bank meeting compliance standards.

30. The system of claim 18, wherein the one or more rules pertain to parameters of the container bank meeting specifications of a manufacturer of the container bank.

31. The system of claim 18, wherein the fire suppressant agent container bank configuration corresponds to a manifold for storing clean agents.

32. The system of claim 18, wherein creating the fire suppressant agent container bank configuration includes creating a data structure of the fire suppressant agent container bank configuration corresponding to a REVIT^{®} family instance.

33. The system of claim 18, wherein the fire suppressant agent container bank configuration is used in a design for a fire suppressant system for a real-world building.

34. The system of claim 18, wherein the operations for generating the data specifying the portion of the main pipe, generating the data specifying the side pipe, and generating the data specifying the extension of the portion of the main pipe to the third connector are iteratively performed to generate multiple sub-portions of the fire suppressant agent container bank configuration; and
wherein the fire suppressant agent container bank configuration includes each of the multiple sub-portions.

35. A method for automating design of a fire suppressant system for a real-world building, the method comprising:
receiving parameters defining a container bank that includes a plurality of containers storing fire suppressant agents;
identifying a first connector and a second connector associated with the container bank;
based at least in part on the parameters defining the container bank:
generating data specifying a portion of a main pipe extending between the first connector and the second connector;
generating data specifying a side pipe extending between the first connector and a check valve outlet in the container bank; and
generating data specifying an extension of the portion of the main pipe to a third connector;
verifying that transition fittings connected to the main pipe in the container bank are in accordance with one or more rules associated with the parameters defining the container bank; and
creating the fire suppressant agent container bank configuration to include the main pipe, the side pipe, and the transition fittings.

36. A computer-readable storage medium storing instructions that, when executed by a computing system, cause the computing system to perform operations for automating design of a fire suppressant system, the operations comprising:
receiving parameters defining a container bank that includes a plurality of containers storing fire suppressant agents;
identifying a first connector and a second connector associated with the container bank;
based at least in part on the parameters defining the container bank:
generating data specifying a portion of a main pipe extending between the first connector and the second connector;
generating data specifying a side pipe extending between the first connector and a check valve outlet in the container bank; and
generating data specifying an extension of the portion of the main pipe to a third connector;
verifying that transition fittings connected to the main pipe in the container bank are in accordance with one or more rules associated with the parameters defining the container bank; and
creating the fire suppressant agent container bank configuration to include the main pipe, the side pipe, and the transition fittings.

37-75. (canceled)
